(19) United States
(12) Patent Application Publication
(10) Pub. No.: US 2016/0070409 A1
(43) Pub. Date: Mar. 10, 2016

(54) CONTROL APPARATUS, INFORMATION SYSTEM, DISPLAY CONTROL METHOD AND MEDIUM

(71) Applicant: FUJITSU LIMITED, Kawasaki-shi (JP)

(72) Inventors: MASASHI UYAMA, Kako (JP); KENJI NAKAJIMA, Machida (JP)

(73) Assignee: FUJITSU LIMITED, Kawasaki-shi (JP)

(21) Appl. No.: 14/940,290

(22) Filed: Nov. 13, 2015

Related U.S. Application Data
(63) Continuation of application No. PCT/JP2013/063464, filed on May 14, 2013.

(51) Int. Cl. G06F 3/041; G09G 5/14; G06F 3/0485

(52) U.S. Cl. CPC G06F 3/0416; G06F 3/0412; G06F 3/0485; G09G 5/14

(57) ABSTRACT

A control device according to the present invention is provided with: a means which, in accordance with an operation on an input device, sets one of a plurality of windows as a start window; a means which, in accordance with an operation on the input device, detects, on a window other than the start window, a sequence change operation to switch the data sequence displayed in the plurality of windows to one of a plurality of data sequences that contain the data being displayed in the start window; and a sequence change means which, on the basis of the sequence change operation, switches the data sequence displayed in the plurality of windows from a first data sequence to a second data sequence while maintaining intact the data displayed in the start window.

### CROSS-REFERENCE TO RELATED APPLICATION

This application is a continuation application of International Application PCT/JP2013/063464 filed on May 14, 2013 and designated the U.S., the entire contents of which are incorporated herein by reference.

### BACKGROUND

The present invention pertains to a display control technology of displaying information.

Data having a sequential structure exist as data to be displayed by an information processing apparatus on a display device. The data having the sequential structure can be exemplified by document data containing a plurality of pages with sequence numbers being applied, data of a schedule book containing a plurality of pages with sequential dates being applied, and other equivalent data. The data having the sequential structure are implemented using an array or a linear list on an information processing apparatus. When displaying such type of data on a display device, a plurality of windows is employed as the case may be.

FIG. 1 is a diagram illustrating a process of displaying a series of data having the sequential structure. FIG. 1 illustrates a process in which the information processing apparatus displays data A, B, . . . , G numbered with page numbers P1-P7 in two windows, i.e., Window1 and Window2. For example, when the data B of the page P2 and the data C of the page P3 are displayed in Window1 and Window2 and when a user pages through by one, the information processing apparatus displays the data C of the page P3 and the data D of the page P4 in Window1 and Window2.

As in FIG. 1, the use of the plurality of windows enables the information processing apparatus to display the pages corresponding to the number of windows. The user can therefore refer to the plurality of pages at one time, and hence this display mode has higher convenience than displaying the pages by using a single window. Further, the user can proceed reading rapidly by introducing a paging-through operation to update display pages in the plurality of windows by one operation. The paging-through operation can be attained by using an input device instanced by a button, trackball, touch panel and touch pad for the paging-through. The touch panel or the touch pad may be configured to detect a flick operation.

By the way, it may happen that the user refers to one page, which triggers a desire for referring to another series of data related to the page being currently referred to. For example, the user, when browsing mails sequenced by dates, remembers another affair requested from a sender of the mail being currently displayed and happens to have a desire for displaying a series of mails sorted on a sender-by-sender basis as the case may be. Another instance is exemplified such that the user conducting an approval process in office implements the approval process by referring to a series of an approval target document data, during which process the user happens to have a desire for displaying another series of approval processing target document data as the case may be.

FIG. 2 is a diagram illustrating a process of two types of series of data each having the sequential structure. Herein, such a case is assumed that the user displays data A, B, C, D, E, F, G of a series 1 instanced by sequential information of the pages P1 through P7. Another case is further assumed of the user displaying another series 2 containing the data D. Herein, the series 2 is a series of data containing data u, A, v, w, D, x, y having sequential information of Q1 through Q7. In other words, the user desires to display the data to be displayed in the plurality of windows by a changeover to another series 2 in a status of displaying the data D specified by the sequential information P4 in the series 1 in Window2 as the case may be. Herein, the data D has the sequential information Q5 in the series 2. In the series 2, information immediately before the data D is data w having the sequential information Q4.

### DOCUMENTS OF PRIOR ARTS

### Patent Documents

[Patent Document 1] Japanese Patent Application Laid-Open Publication No. 2008-152585

[Patent Document 2] Japanese Unexamined Patent Publication No. 2009-508230

[Patent Document 3] Japanese Patent Application Laid-Open Publication No. 2000-105772

### SUMMARY

One aspect of the embodiment of the disclosure can be exemplified as a control device connectable to a display device to display a plurality of windows and to an input device to detect an operation on the plurality of windows.

The control device includes one or more processors and a storage device storing instructions. The instructions cause the one or more processors to execute a process. The process includes setting one of the plurality of windows as a fiducial window, based on an operation on the input device; detecting a series change operation of changing over a series of data to be displayed in the plurality of windows from within a plurality of series of data containing data under display in the fiducial window, the detecting being done in any of the plurality of windows other than the fiducial window, based on an operation on the input device; and changing over the series of data to be displayed in the plurality of windows from a first series of data to a second series of data in a status of fixing the data being displayed in the fiducial window, based on the series change operation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating a process of displaying a series of data each having a sequential structure;

FIG. 2 is a diagram illustrating a process of displaying two types of series of data each having the sequential structure;

FIG. 3 is a diagram illustrating an operation example of changing a series of data in an information processing apparatus adopting a popup menu;

FIG. 4 is a diagram illustrating another operation example of changing a series of data in the information processing apparatus adopting the popup menu;

FIG. 5 is a diagram illustrating a screen example of a mail browsing tool;

FIG. 6 is a diagram illustrating a plurality of series of data;

FIG. 7 is a diagram illustrating an example of a configuration of function blocks of the information processing apparatus in an Example 1;

FIG. 8 is a diagram illustrating a hardware configuration of the information processing apparatus.

FIG. 9 is a diagram illustrating one example of an associative table;

FIG. 10 is a diagram illustrating an example of a page attribution table;

FIG. 11 is a diagram illustrating a changeover candidate list.

FIG. 12 is a flowchart illustrating an operation of an event processing unit;

FIG. 13 is a flowchart illustrating a paging-through process;

FIG. 14 is a flowchart illustrating a pinning process.

FIG. 15 is a flowchart illustrating a pinning cancelation process;

FIG. 16 is a flowchart illustrating a fiducial mode start process.

FIG. 17 is a flowchart illustrating a fiducial mode process.

FIG. 18 is a flowchart illustrating details of a scroll process;

FIG. 19A is a diagram illustrating an operation on a screen;

FIG. 19B is a diagram illustrating an operation on the screen;

FIG. 19C is a diagram illustrating an operation on the screen;

FIG. 20A is a diagram illustrating an operation on a screen;

FIG. 20B is diagram illustrating an operation on the screen;

FIG. 20C is a diagram illustrating an operation on the screen;

FIG. 21A is a diagram illustrating an operation on a screen;

FIG. 21B is a diagram illustrating an operation on the screen;

FIG. 21C is a diagram illustrating an operation on the screen;

FIG. 22 is a flowchart illustrating a fiducial mode process 2 in an Example 2;

FIG. 23 is a flowchart illustrating the scroll process in the Example 2;

FIG. 24 is a flowchart illustrating a scroll sub-process;

FIG. 25 is a diagram illustrating a configuration of function blocks of an information system in an Example 3;

FIG. 26 is a diagram illustrating function blocks of the paging-through processing unit in the Example 3;

FIG. 27 is a flowchart illustrating an event reception process;

FIG. 28 is a flowchart illustrating an associative table update process.

FIG. 29 is a flowchart illustrating a fiducial mode clearing process;

FIG. 30 is a flowchart illustrating an operation of a fiducial mode setting process;

FIG. 31 is a flowchart illustrating an operation of a line update process;

FIG. 32 is a flowchart illustrating an operation of the paging-through processing unit in the Example 3;

FIG. 33 is a flowchart illustrating the pinning process in the Example 3;

FIG. 34 is a flowchart illustrating the pinning cancelation process in the Example 3;

FIG. 35 is a flowchart illustrating the fiducial mode start process in the Example 3;

FIG. 36 is a flowchart illustrating the fiducial mode process in the Example 3;

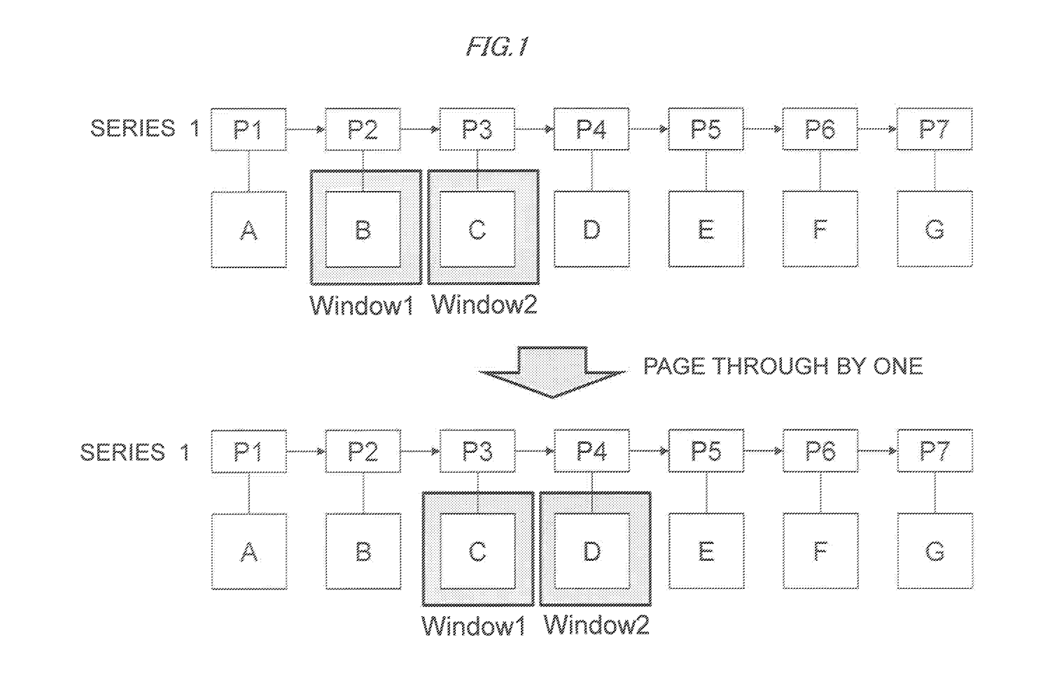

### DETAILED DESCRIPTION

An information processing apparatus according to an embodiment for carrying out one aspect of the present invention will hereinafter be described with reference to the drawings. A configuration of the following embodiment is an exemplification, and the information processing apparatus is not limited to the configuration of the embodiment.

### COMPARATIVE EXAMPLE

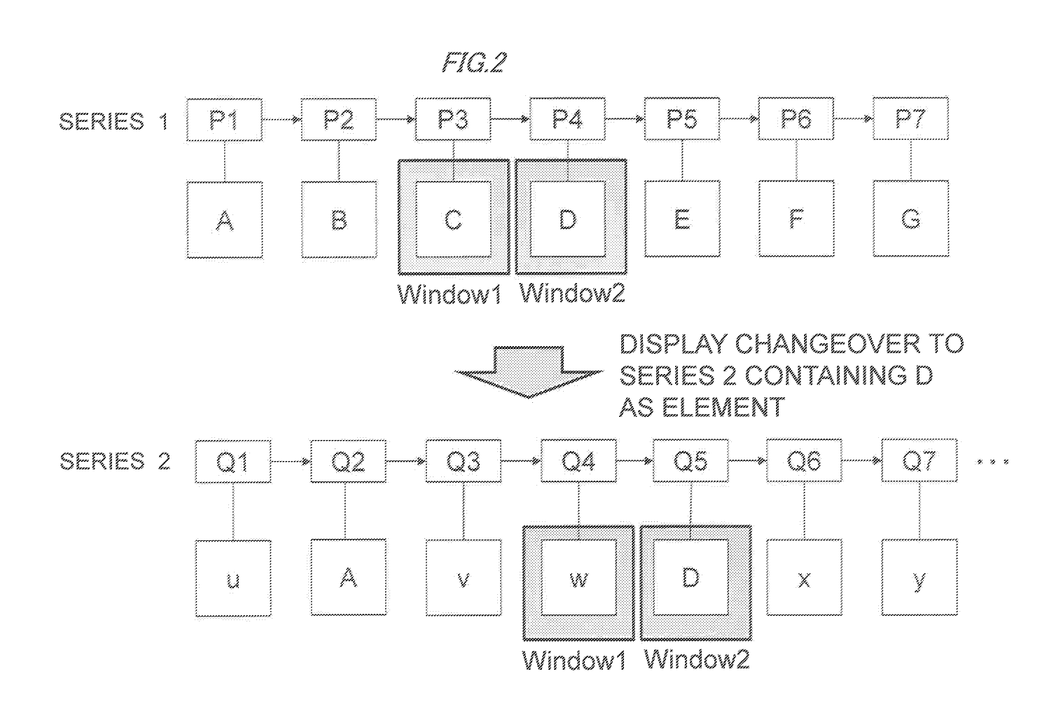

Exemplified hereinafter is a process in which the information processing apparatus according to a comparative example displays a series of data. The comparative example exemplifies a user interface when changing over display between plural series of data including some overlapped data illustrated in FIG. 2. For example, the information processing apparatus changes a series of data to be displayed when a series of data (series 1) includes data A, B, C, D, E, F, G and when a series of data (series 2) includes data u, A, v, w, D, x, y.

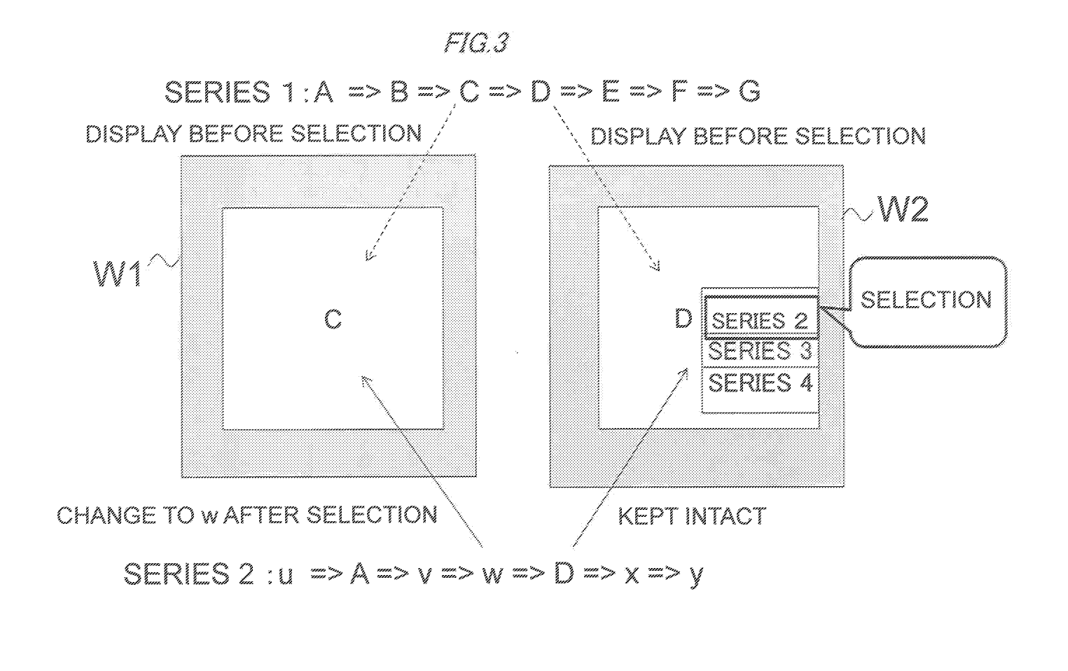

FIG. 3 depicts an operation example of the data line being changed in the information processing apparatus adopting a popup menu as the user interface. Herein, windows S1, w2 are displayed on a display device of the information processing apparatus. The data C is displayed on the window W1, and the data D is displayed in the window W2.

A processing example in FIG. 3 is that the information processing apparatus displays the popup menu of a menu list containing names of series 2, 3, 4 and other equivalent series. When a user selects the names of series (which will hereinafter be termed the series names) from the menu list of the popup menu, the information processing apparatus executes actions associated with the series names. To be specific, the information processing apparatus displays the series of data, specified by the series names of selected by the user, in the windows W1, W2.

To be more specific, as in FIG. 3, the user, when desiring to change over the display to another series of data to which the data D belongs, operates the information processing apparatus to display a list of series to which the data D belongs by popping up the popup menu on the window W2 in which the data D is currently displayed. The user selects one series from within the displayed list of series, and changes over the display to the selected series of data.

Between different series of data, however, when changing over the display to another series of data containing the data under reference in a status of keeping the display of the data under the reference, the operation on the user interface in FIG. 3 does not become desirable as the case may be. For example, such a case is considered that the series of data to be displayed is changed over to the series 2 while keeping the display of the data D displayed in the window W2 in FIG. 3. An example in FIG. 3 is that the data under the display in the series 1 are the data C and D, while data immediately before the data D in the series 2 is data w.

In the operation example of FIG. 3, no change is seen in content displayed in the operated window W2, and, by contrast in the non-operated window W1, the data to be displayed changes over to the data w from the data D. In other words, it follows that a change occurs in the non-operated window W1 as a response to the operation on the window W2, and any intuitive relationship is not established between the user's operation on the user interface and a displayed result related to the user's operation. In other words, such a problem arises that the user is unable to determine whether the operation by himself is surely conducted because of not having a proper feedback to the operation result in some cases.

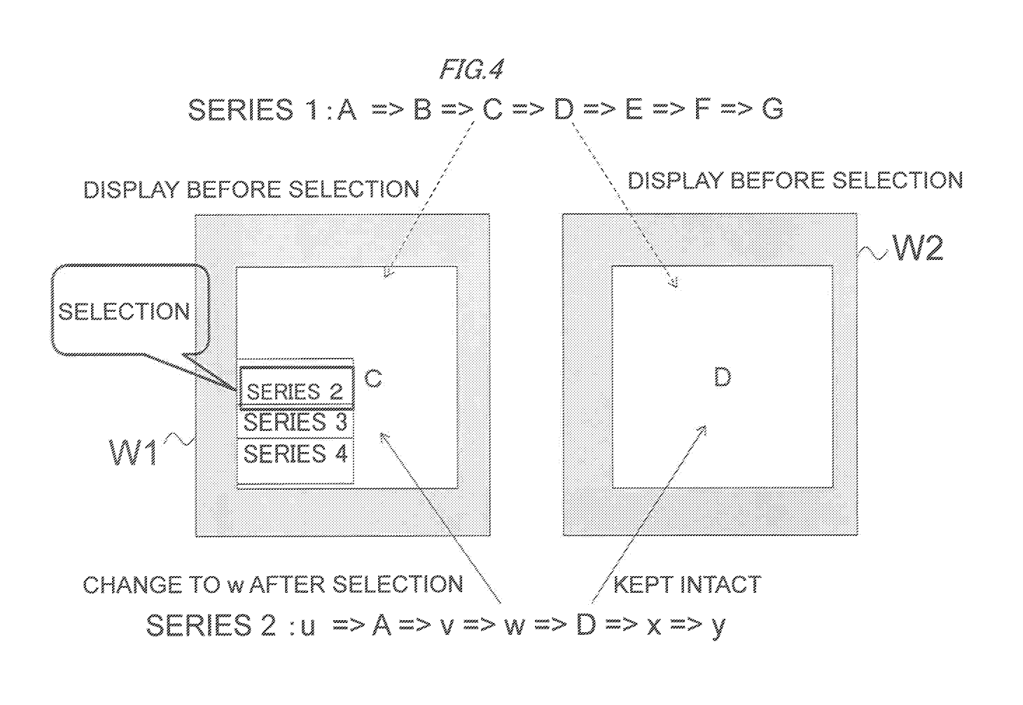

FIG. 4 depicts another operation example in the information processing apparatus with the popup menu adopted as the user interface. Similarly to FIG. 3, FIG. 4 illustrates the windows W1, W2 displayed on the display device of the information processing apparatus. The data C is displayed in the window W1, and the data D is displayed in the window W2. In an operation example of FIG. 4, however, the list of series is displayed not in the window W2 displaying the data D, of which the display is desired to be kept by the user, but in the window W1. Then, the user selects one series of data from within the list of series displayed in the window W1 to change over the display. The operation example in FIG. 4 conforms to a concept that the window W1 with occurrence of a changeover of the display to the data w from the data C under the display through the user′ operation. However, an instance of FIG. 4 is that the data displayed in the window W1 operated by the user are the pre-changing data C and the post-changing data w, while on the other hand the list of the popup menu displayed in the window W1 is an option of the series of data containing the data D displayed in the window W2. In other words, the operation in FIG. 4 results in popping up the option in the window W1 displaying the operation target data C, the option being related to the data D in the window W2 different from the operation target of the user. A display result in the window W1 in the operation example of FIG. 4 is not therefore said to be a proper feedback. Accordingly, a problem is caused of a determination being difficult to select a user's own intended operation.

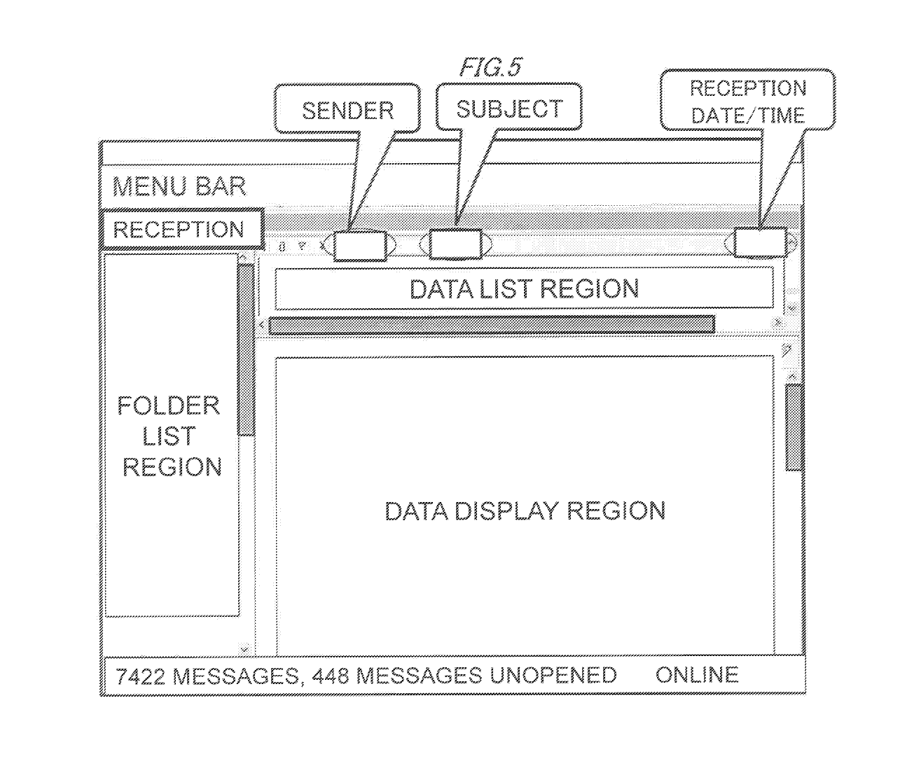

FIG. 5 illustrates a screen example of a general mail browsing tool. The example in FIG. 5 is that the information processing apparatus displays a window having three display regions, i.e., a folder list region, a data list region and a data display region on the display device. Note that details of a menu bar are omitted in FIG. 5. A “reception” folder is displayed as a folder when receiving a mail in the folder list region.

For example, a series of data is displayed as a form of list in the data list region. One piece of data is selected from the list and displayed in the data display region. Herein, the user presses buttons, i.e., a “sender” button, a “subject” button and a “reception date/time” button arranged in an upper bar of the data list region, thereby enabling a changeover of the data list in the data list region while keeping intact the display in the data display region. For instance, the user can change over a series of reception mails sorted by reception date/time to a series of reception mails sorted by subjects. The list display in the data list region is changed over by user's pressing the button in the data list region, and a proper feedback is therefore given in response to the user′ operation. To give another example, it is also considered to apply an operation example of Japanese Patent Application Laid-Open Publication No. 2000-105772, in which a plurality of series of data is displayed in a much wider window.

However, an operation method in the example of the screen for the mail browsing tool and other equivalent screens does not provide any contrivance to update the display pages in the plurality of windows and to page through by one single operation. Further, when the series of data containing the object data of a user's interest is displayed by use of the plurality of windows, the series of data is changed over to another series of data while keeping the display of the interest object data, in which case the operation in the comparative example does not have any operation sense to obtain the direct feedback from the display result after the changeover.

To be specific, when the method illustrated in FIG. 5 is applied to a display control apparatus including a plurality of windows and having an operation function to update the display pages in the plurality of windows by one single operation, the display control apparatus executes operations of:

(1) displaying a part of the series of data of the user's interest object by using the plurality of windows; and
(2) setting a focused piece of data from within the displayed pieces of data by the user's designating one window.
(3) The information processing apparatus performs operations of:
(3-1) generating a data list of the series of data under the display;
(3-2) generating a list of series of data containing the focused data as changeover destination candidates; and
(3-3) displaying a button for the data list and a button for selecting the changeover destination candidate within the window.
(4) The user conducts an operation of selecting the changeover destination by pressing the button.
(5) The information processing apparatus performs operations of:
(5-1) changing over the display of the data list to a changeover destination series of data;
(5-2) replacing the display of the plurality of windows by the selected new series of data; and
(5-3) erasing the data list after the changeover and the button for selecting the changeover destination candidate.

As by the operation (1) of the operation examples described above, a part of the data line of the user's interest object is already displayed by using the plurality of windows. Despite being displayed as by the operation (1), it follows that additional operations, i.e., the operation (3-1) of generating the data list of series of data, the displaying operation (3-3) and the erasing operation (5-3), are carried out.

Further, the operations (1) through (5) are incompatible with the direct sense of operation provided by a flick operation used for paging through and other equivalent operations. The paging-through based on the flick operation spreading on smartphones and other equivalent terminal devices acquires the direct sense of operation by continuously changing the screen display following up a finger action of the user from a start of the operation to an end thereof with respect to an operation target indicated by the user's finger. The information processing apparatus enabling the paging-through based on the flick operation temporarily generates and displays the changeover destination candidates, and prompts the user to select the target candidate with the button when adopting the operations (1) through (5). Consequently, such a possibility might occur that the operations (1) through (5) are different from the direct sense of operation provided by the flick operation. Accordingly, the operations (1) through (5) have a possibility that consistency of the user interface is lost to cause a sense of being hard to operate on the side of the user.

### Example 1

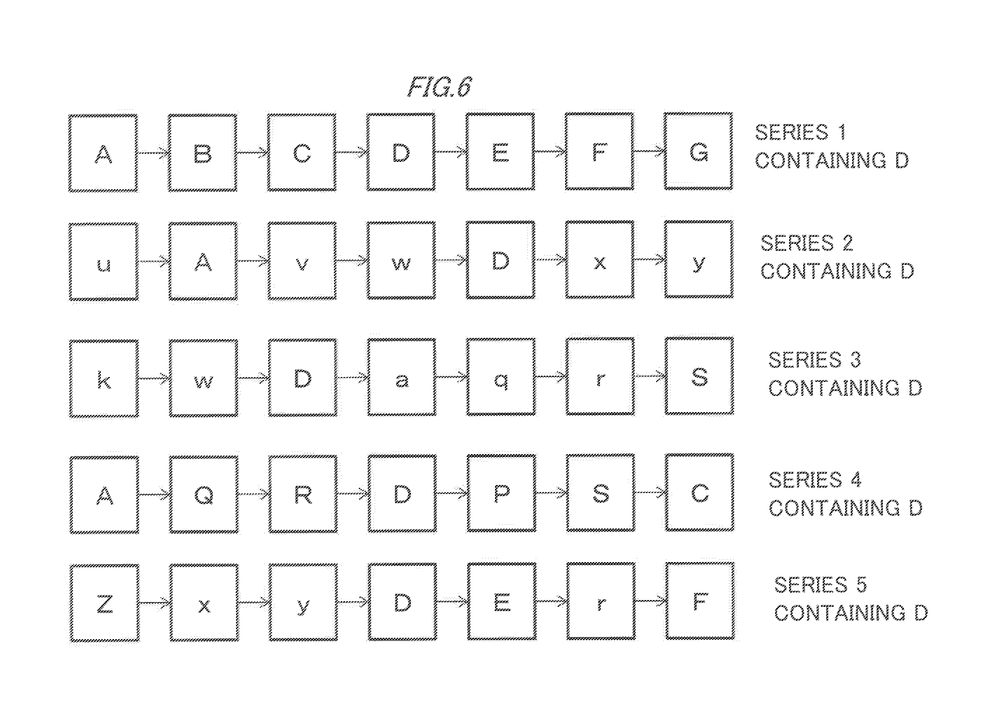

An information processing apparatus 10 according to a first example (Example 1) will be described with reference to FIGS. 6 through 21C. The information processing apparatus 10 in the Example 1 has a plurality of windows and updates display images displayed in the windows by a user's page changing operation. The information processing apparatus 10 improves operability when a user desires to refer to another series of data related to this single page upon a trigger that the user refers to one page. For example, the information processing apparatus 10 changes over the series of data displayed in the plurality of windows to another series of data containing the triggering page and displays the changed-over series of data while keeping the display of the triggering page itself.

The user can indicate the operation target series of data itself by using a pointing device instanced by a mouse, a touch panel and other equivalent devices. The information processing apparatus 10 therefore provides a feedback following up the user's action from the start to the end of the user's operation to give the direct sense of operation to the user, thus providing a sense of operation having the consistency with the paging-through based on, e.g., the flick operation.

<Series of Data>

FIG. 6 illustrates a plurality of series of data set as a processing target of the information processing apparatus 10 according to the Example 1. FIG. 6 depicts the plurality of series of data (series 1-5) each containing the data D as a common element. The series 1 of data contains data A, B, C, D, E, F, G in this arrangement sequence. The series 2 of data contains data u, A, v, w, D, x, y in the arrangement sequence. The series 1 and series 2 contain the data A and the data D in common.

For example, the user displays the series 1 of data in the plurality of windows, during which the information processing apparatus 10 according to the Example 1, when focusing on the data D, enables an operation of changing over the display target on the plurality of windows to the series 2 of data from the series 1 of data in a status of keeping the display of the data D. Note that the information processing apparatus 10 does not limit the number of series of data as the processing target of the information processing apparatus to “2”, and enables the changeover of the display target further to the series 3, 4, 5 of data and other equivalent series of data. It is to be also noted that the information processing apparatus 10 does not limit the number of display windows when displaying the series of data as illustrated in FIG. 6.

<Configuration>

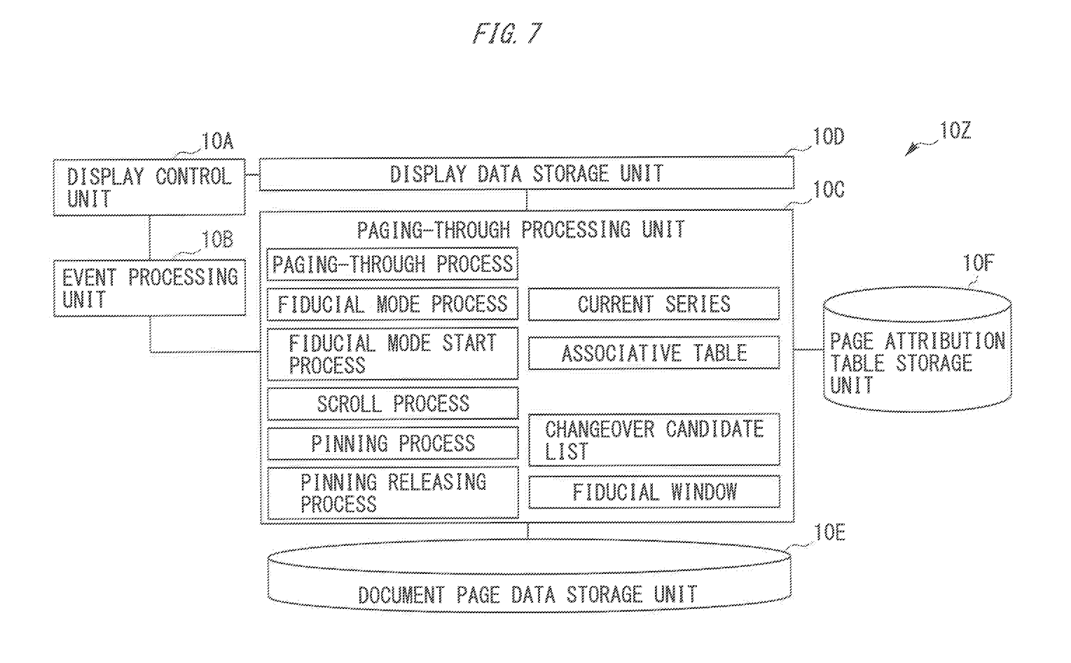

FIG. 7 illustrates an example of a configuration of processing blocks of a control apparatus 10Z included in the information processing apparatus 10 according to the Example 1. The control apparatus 10Z includes a display control unit 10A to control the display in the plurality of windows, an event processing unit 10B, a paging-through processing unit 10C, a display data storage unit 10D, a document page data storage unit 10E, and a page attribution table storage unit 10F. The control apparatus 10Z provides processes based on the respective components in FIG. 7 by, e.g., a CPU (Central Processing Unit) executing a computer program deployed in an executable manner on a main storage device. However, the control apparatus 10Z may also provide at least a part of processes executed by the respective components in FIG. 7 through a dedicated hardware circuit.

The display control unit 10A displays the display data in the respective windows on a display device 16 in FIG. 8, the display data being stored in the display data storage unit 10D. The number of windows displayed on the display device 16 is to be “4” in the Example 1. A window number, which is any one of integer values “1” through “4”, is to be allocated to each window.

A main storage device 12 in FIG. 8 includes the display data storage unit 10D. The display data storage unit 10D may, however, be provided on a graphics board and other equivalent controllers to control the display device 16. The display data storage unit 10D may also have the same number of data retaining areas, which are, e.g., the four areas, as the number of windows.

The event processing unit 10B configured to assign a process to be executed in response to an event that occurs corresponding to the user's operation, starts the process upon the occurrence of the event. For instance, when the user performs an operation on the window, an event corresponding to the operation on the window occurs, and the event processing unit 10B acquires the window number of the window with the occurrence of the event, an event ID specifying the event, and other equivalent items of data.

When the event ID specifies the paging-through operation, the event processing unit 10B starts up a process of the paging-through processing unit 10C. The process of the paging-through processing unit 10C is, however, different depending on whether a fiducial window exists for the displayed window. The fiducial window connotes a window that is a criterion for detecting the user's operation with respect to the plurality of windows. The fiducial window becomes the criterion for controlling a positional relation between the respective windows, a scroll speed and other equivalent data when changing a content of the display by the operation, and other equivalent situations.

The event processing unit 10B, when the fiducial window exists, executes a fiducial mode process of the paging-through processing unit 10C. Whereas when the fiducial window does not exist, the event processing unit 10B executes a normal paging-through process. For example, the event processing unit 10B refers to the event ID and, when the event indicates a next paging-through operation, increments a paging-through count by “1” (+1) to execute the paging-through process of the paging-through processing unit 10C. By contrast, when the event indicates a previous paging-through operation, the event processing unit 10B decrements the paging-through count by “1” (−1) to execute the paging-through process of the paging-through processing unit 10C.

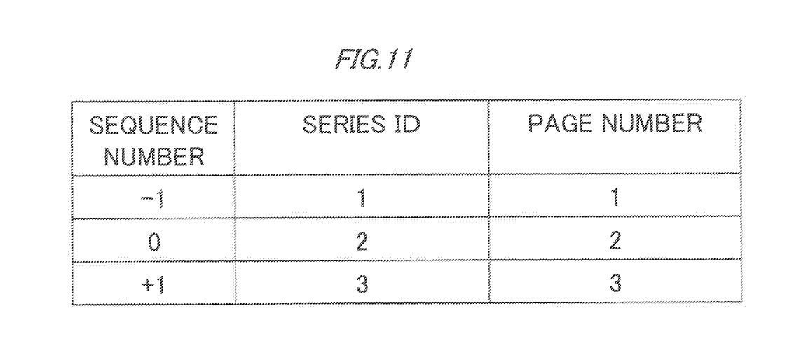

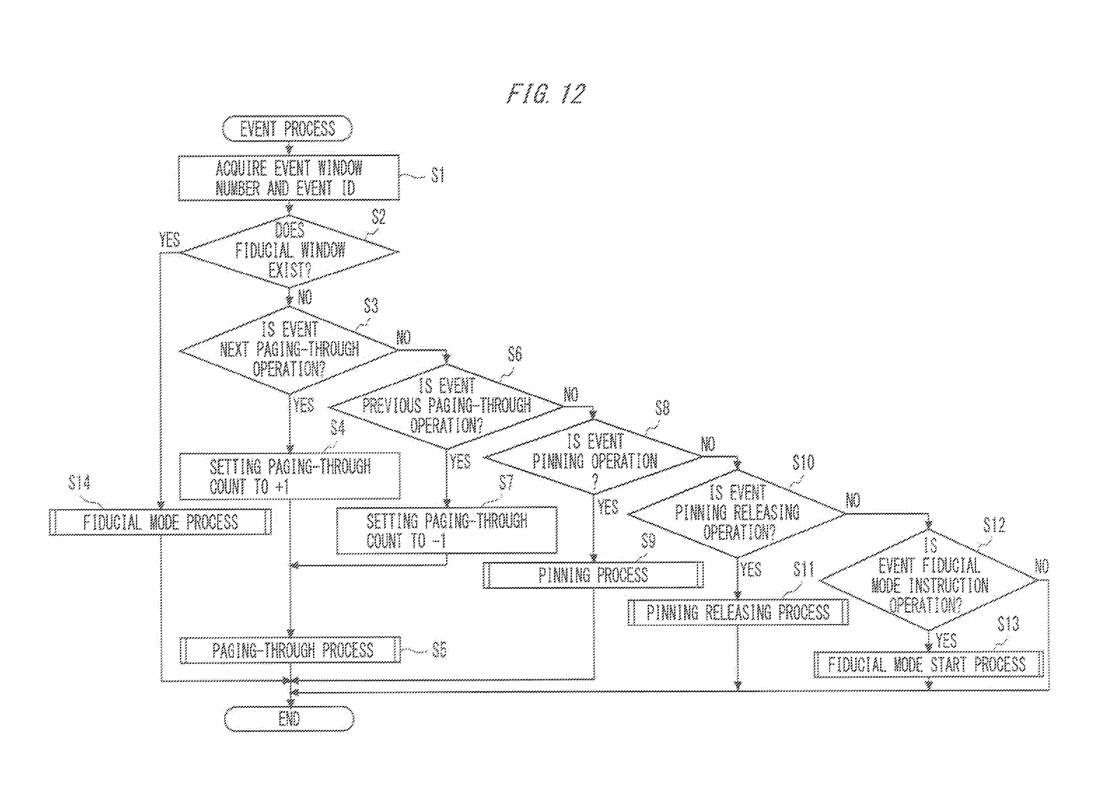

When the event indicates a pinning operation, the event processing unit 10B performs a pinning process of the paging-through processing unit 10C. Whereas when the event indicates a pinning releasing operation, the event processing unit 10B performs a pinning releasing process of the paging-through processing unit 10C. When the event indicates a fiducial mode instruction operation, the event processing unit 10B executes a fiducial mode start process of the paging-through processing unit 10C. An in-depth description of the event processing unit 10B will be made later based on FIG. 12.

The paging-through processing unit 10C retains management information instanced by a present series of data, an associative table, a changeover candidate list, a fiducial window and other equivalent information in the main storage device 12 of FIG. 8. The present series of data is information specifying the series of data displayed currently by the display control unit 10A in the plurality of windows on the display device 16.

The associative table is a table representing an associative relation between each window currently displayed by the display control unit 10A on the display device 16 and the page under the display at the present, and also an associative relation between each window and a new page to be displayed next.

The changeover candidate list is a list of names of series of data as the changeover destination candidates from which to specify the changeover destination series of data when performing the operation to change over the series of data by the flick operation in a status that the fiducial window exists. A specific example of the changeover candidate list will be described later based on FIG. 11.

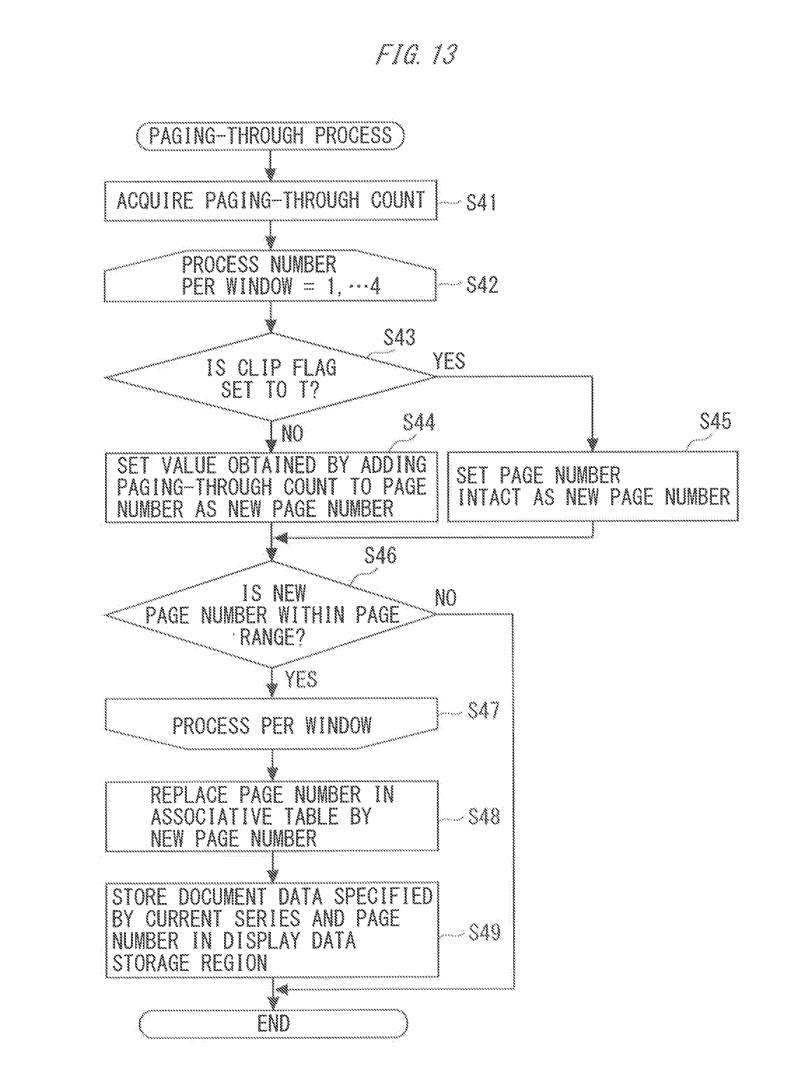

The paging-through processing unit 10C executes, based on instructions given from the event processing unit 10B, a paging-through process, a fiducial mode process, a fiducial mode start process, a scroll process, a pinning process, a pinning releasing process and other equivalent processes. The paging-through process, the fiducial mode process, the fiducial mode start process, the pinning process and the pinning releasing process will be described later in FIGS. 13 through 18.

The paging-through process connotes a process of changing the display page in the series of data defined as a row of pages sequenced by page numbers.

The fiducial mode process connotes a process of calculating, e.g., a distance between a window ID of the window with the user's flick operation being conducted and a window ID of the fiducial window on the basis of the fiducial window when the fiducial window is set, and determining the series of data to be displayed in the plurality of windows from the calculated distance and a flick speed. The fiducial mode start process connotes a process of setting the fiducial window according to the user's operation and generating the changeover candidate list.

The scroll process in the Example 1 connotes, unlike the simple paging-through process, a process of displaying the data while making a transition of the series of data displayed in the plurality of windows to the series of data set in the fiducial mode process from the series of data under the display at the present.

Details of the pinning process are disclosed in Japanese Unexamined Patent Publication No. 2009-508230, and hence a description thereof will hereinafter be outlined. The pinning process is a technique of fixing the displayed content in one window while changing another window by paging-through process. For instance, there is an assumption of an e-book being compiled to arrange a chapter “Answers” after a chapter “Questions”. In this instance, the user can perform operations such as fixing a Question page displayed in one window by “pinning” and seeking for an Answer page matching with the Question page by repeatedly paging through in another window. A pinning operation is defined as user's setting for the paging-through processing unit 10C to execute the pinning process.

The pinning process is executed by adding a flag, indicating whether being pinned, to the associative table retaining the window numbers and the page numbers, corresponding to the pinning operation of the user. The paging-through processing unit 10C excludes the window with the pinning operation being done from page number increment/decrement targets of the paging-through processing unit 10C.

The pinning releasing process is a process of finishing the pinning process. The user can, after conducting the pinning operation, perform the paging-through operation in another window, and can page through by synchronizing the two separate pages after further finishing the pinning operation. For example, it may be sufficient that the user cancels the pinning process after displaying the page of the chapter “Questions” and the page of the chapter “Answers” in a side-by-side relation by the pinning operation. The pinning cancelation enables the user to page through one by one both of the page of the chapter “Questions” and the page of the chapter “Answers” by the paging-through operation in a way that associates these pages with each other.

The document page data storage unit 10E stores the series of data defined as the row of pages sequenced by the page numbers. The document page data storage unit 10E is included by, e.g., the main storage device 12, an external storage device 13 and a portable storage medium connected to a portable storage medium connecting device 15 in FIG. 8 and other equivalent mediums.

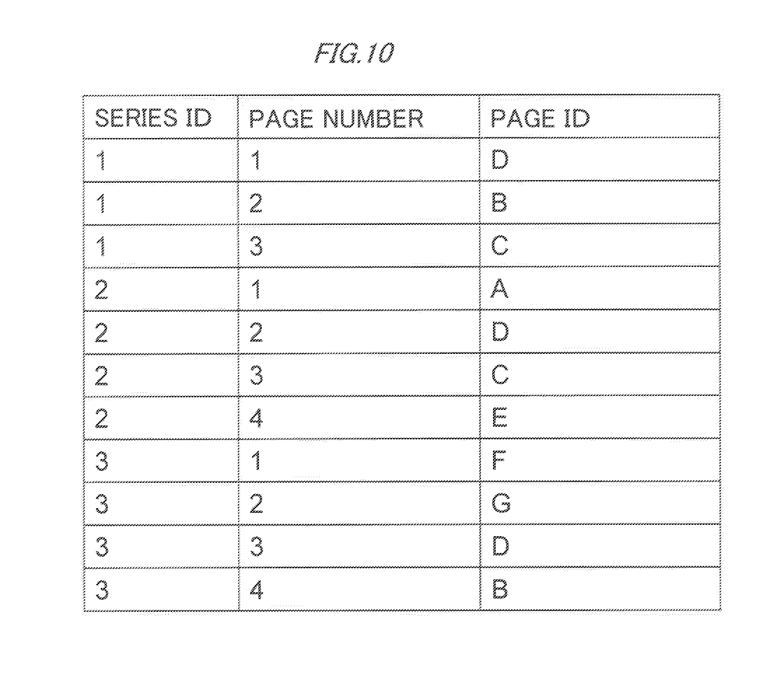

The page attribution table storage unit 10F is included by, e.g., the main storage device 12, the external storage device 13 and the portable storage medium connected to the portable storage medium connecting device 15 in FIG. 8 and other equivalent mediums. The page attribution table storage unit 10F stores a page attribution table. The page attribution table is a table that defines indices indicating attribution series and an intra-series sequence with respect to the data of the respective pages. A specific example of the page attribution table will be described later in FIG. 10.

FIG. 8 illustrates a hardware configuration of the information processing apparatus 10. The information processing apparatus 10 includes, a CPU 11, the main storage device 12, the external storage device 13, a communication interface 14, the portable storage medium connecting device 15, the display device 16, an input device 17 and other equivalent components.

The CPU 11 provides functions of the information processing apparatus 10 by executing the computer program deployed in the executable manner on the main storage device 12. The CPU 11 may be a multi-core processor without being limited to a single core processor.

The main storage device 12 stores the computer program to be executed by the CPU 11 and data or other equivalent information to be processed by the CPU 11. The main storage device 12 may be configured to include a nonvolatile ROM (Read Only Memory) and a volatile DRAM (Dynamic Random Access Memory). The external storage device 13 is exemplified by a hard disk driven by a hard disk drive, a solid state drive (SSD) using a flash memory, and other equivalent storages. The external storage device 13 stores the computer program deployed on the main storage device 12 or the data and other equivalent information that are processed by the CPU 11.

The communication interface 14 is also called a NIC (Network Interface Card). The communication interface 14 is an interface instanced by a LAN (Local Area Network) interface, a wireless LAN interface, a mobile phone communication unit and other equivalent interfaces. The portable storage medium I/O device 15 is an input/output device for, e.g., a CD (Compact Disc), a DVD (Digital Versatile Disk), a Blu-ray disc, a flash memory card and other equivalent storage mediums. The CPU 11, the main storage device 12 and the communication interface 14 correspond to the control apparatus 10Z in FIG. 7.

The display device 16 is exemplified by a liquid crystal display, an electroluminescence panel and other equivalent displays. The input device 17 is an input device instanced by a keyboard, a mouse, a touch panel, an electrostatic pad, a touch pad and other equivalent devices.

It is to be noted that FIG. 8 depicts a single computer as the information processing apparatus 10. The information processing apparatus 10 may also be, however, a system including a plurality of computers that mutually cooperates in executing processes by sharing.

<Example of Data>

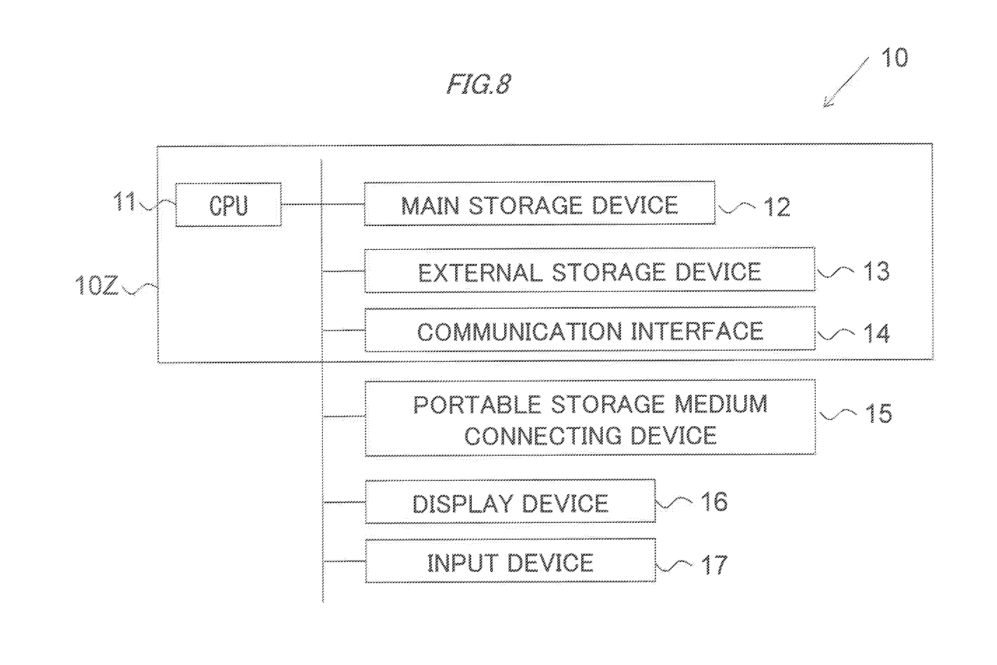

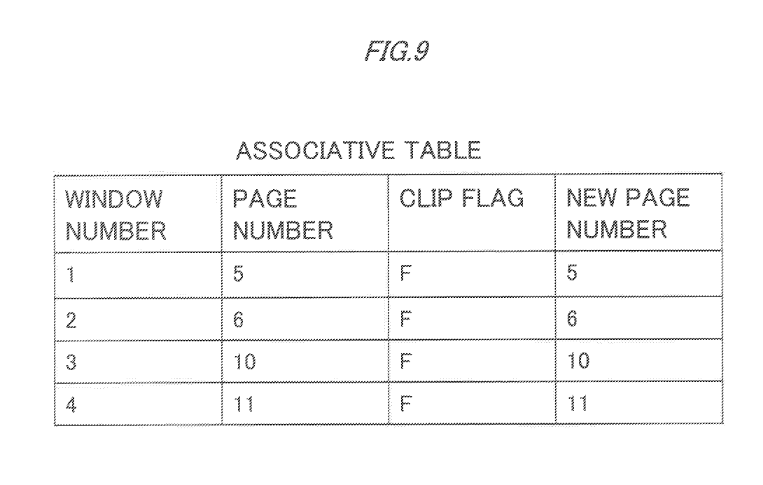

FIG. 9 illustrates one example of the associative table managed by the paging-through processing unit 10C. The associative table is a two-dimensional table to manage the data sequenced by the page numbers displayed in the respective windows. The associative table has rows corresponding to the numbers of windows managed by the paging-through processing unit 10C. Each row of the associative table contains fields, i.e., a “window number” field, a “page number” field, a “clip flag” field and a “new page number” field.

The window number is identifying information of the window displayed on the display device 16 of the information processing apparatus 10. The page number is a page number of the data displayed in the window specified by the window number. The clip flag indicates “true” (T) or “false” (F) about whether the data specified by the page number is displayed in a state of being pinned in the window specified by the window number. The new page number is a page number of the page to be displayed next in the paging-through process. The page number indicates a sequential order of each page in the series of data, i.e., defines which number of page the data is contained in. The page number is, e.g., a serial number of the page in each series.

FIG. 10 illustrates an example of the page attribution table. The page attribution table specifies which series the data of each page identified by the page ID is attributed to, and also which sequential number the page in the attribution series has. As in FIG. 10, each of rows (records) of the page attribution table contains a “series ID” field, a “page number” field and a “page ID” field.

The series ID is information for identifying the series of data. The series of data connotes a series of sequenced data, and is exemplified as an aggregation of pages sequenced by the page numbers according to the Example 1. The page number indicates the sequential order of each page in the series of data, i.e., defines which number of page the data is contained in. The page ID is data for identifying the page. In the page attribution table, the data of the page having the same page ID may be attributed to a plurality of series. Accordingly, the page attribution table has a possibility of containing a plurality of rows having the same page number.

The Example 1 assumes that the page attribution table is defined by, e.g., an implementor of the data. For example, it is assumed that the implementor of the data allocates the data sorted by date as the series ID=1, the data sorted by client as the series ID=2, the data sorted by title as the series ID=3, and other equivalent data.

The information processing apparatus 10 may, however, provide a tool for generating the page attribution table. For instance, an assumption is that document data containing combinations of pluralities of same pages are sorted into different series. The series of data are generated by sorting, in which case it may be sufficient that the information processing apparatus 10 provides a window having a field for specifying the line ID and a field for specifying a sorting key on the screen serving as the user interface. It may be sufficient that the information processing apparatus 10 sets the page number, based on the sequential order of the sorted data according to a user's designation.

FIG. 11 illustrates an example of the changeover candidate list extracted and generated from the page attribution table in the fiducial mode start process. Each of rows (records) of the changeover candidate list contains a “series ID” field of the series of data containing data of the page under the display in the fiducial window (this data will hereinafter be termed fiducial data), a “page number” field of the fiducial data in each series, and a “sequence number” field. For instance, an assumption is given of providing the page attribution table depicted in FIG. 10 and displaying the series of data having the series ID of “2” (ID=2) in the plurality of windows. It is further assumed that the data with the page ID being “D” (ID=D) is currently displayed in the fiducial window. In this case, the data with the page ID=D is the data of the page specified by the page number=2 in the series of data specified by the series ID=2.

Further, the data with the page ID=D is the data of the page specified by the page number=1 in the series of data specified by the series ID=1. When the information processing apparatus 10 changes over the series of data displayed in the plurality of windows to the series of data specified by the series ID=1, the data in the fiducial window changes to the data of the page specified by the page number=1 in the series of data specified by the series ID=1, though the page ID=D remains unchanged. Accordingly, when changing the series of data to be displayed in the plurality of windows, the data displayed in the window other than the fiducial window is selected and displayed based on the page number=1 of the fiducial window in the series of data specified by the series ID=1.

Similarly, the data having the page ID=D is the data of the page specified by the page number=3 in the series of data specified by the series ID=3. When the information processing apparatus 10 changes over the series of data displayed in the plurality of windows to the series of data specified by the series ID=3, the data in the fiducial window changes to the data of the page specified by the page number=3 in the series of data specified by the series ID=3, though the page ID=D remains unchanged. Hence, when changing the series of data to be displayed in the plurality of windows, the data displayed in the window other than the fiducial window is selected and displayed based on the page number=3 of the fiducial window in the series of data specified by the series ID=3.

Thus, the page number on the changeover candidate list retains the sequential order in each series of data given to the data displayed currently in the fiducial window. The information processing apparatus 10 determines the page (data) in a new series of data to be displayed in each window after the changeover of the series, based on the page number on the changeover candidate list.

The sequence number takes a consecutive integer value when the series of data displayed currently in the window among the changeover candidates is specified by a sequence number “0”. The series of data having a sequence number “−1” in the changeover candidate list exists immediately before the current series in the page attribution table and is therefore to be called a just-above series. The series of data having a sequence number “+1” in the changeover candidate list exists immediately after the current series in the page attribution table and is therefore to be called a just-below series.

The paging-through processing unit 10C can extract the changeover candidate list from the page attribution table in, e.g., FIG. 10. When focusing on, e.g., the data of the page specified by the page ID of “D”, as described above, these records are a record containing “1” as the series ID and “1” as the page number (series ID=1, page number=1), a record containing 2″ as the series ID and “2” as the page number (series ID=2, page number=2) and a record containing “3” as the series ID and “3” as the page number (series ID=3, page number=3). It is now presumed that the series of data specified by the series ID=2 are displayed in the respective windows. The series of data specified by the series ID=1 is the just-above line with the sequence number=−1. The series of data specified by the series ID=3 is the just-below line with the sequence number=+1.

<Processing Procedure>

FIGS. 12 through 18 illustrate processing procedures of the information processing apparatus 10. FIG. 12 is a flowchart illustrating an operation of the event processing unit 10B. When the user performs an operation on the window, an OS (Operating System) of the information processing apparatus 10 detects this event and notifies the event processing unit 10B of the event.

The event processing unit 10B, upon receiving the notification from the OS, acquires a window number of the window with the occurrence of the event, and an event ID to specify the event (S1). Next, the event processing unit 10B determines whether the fiducial window exits (S2).

When the fiducial window exists, the event processing unit 10B executes the fiducial mode process by the paging-through processing unit 10C (S14). Whereas when the fiducial window does not exist, the event processing unit 10B refers to the event ID, and thus determines whether the event is a next paging-through operation (S3). When the event is the next paging-through operation, the event processing unit 10B sets a paging-through count to +1 (S4), and executes the paging-through process by the paging-through processing unit 10C (S5). Whereas when the event is not the next paging-through operation, the event processing unit 10B determines whether the event is a previous paging-through operation (S6). When the event is the previous paging-through operation, the event processing unit 10B set the paging-through count to −1 (S7), and executes the paging-through process by the paging-through processing unit 10C (S5).

Whereas when the event is not the previous paging-through operation, the event processing unit 10B determines whether the event is a pinning operation (S8). When the event is the pinning operation, the event processing unit 10B executes a pinning process by the paging-through processing unit 10C (S9). Whereas when the event is not the pinning operation, the event processing unit 10B determines whether the event is a pinning releasing operation (S10). When the event is the pinning releasing operation, the event processing unit 10B executes a pinning releasing process by the paging-through processing unit 10C (S11).

When the event is not the pinning releasing operation, the event processing unit 10B determines whether the event is a fiducial mode instructing operation (S12). The fiducial mode instructing operation is an operation that the user continues pressing against the window desired to be set as the fiducial window. It may be sufficient that the information processing apparatus 10 continues processing from S13 onward during the continuation of pressing against the window. It does not, however, mean that a manner of the fiducial mode instructing operation is particularly limited. The fiducial mode instructing operation may also be a so-called long press operation, in which the user presses against the window desired to be set as the fiducial window longer than a predetermined period of time. The fiducial mode instructing operation may also be an operation to select, e.g., an option from the menu.

When the event is the fiducial mode instructing operation, the event processing unit 10B executes the fiducial mode start process by the paging-through processing unit 10C (S13). Whereas when the event is not the fiducial mode instructing operation, the event processing unit 10B finishes processing. The paging-through processing unit 10C executes the process in S13 by way of one example of setting one of a plurality of windows as a fiducial window. The paging-through processing unit 10C executes the process in S13 by way of one example of setting, by a first computer of the plurality of computers, a first window displayed on the display device of the first computer as a fiducial window.

Under the control of the event processing unit 10B described above, the paging-through processing unit 10C retains the window ID of the fiducial window, the series ID of the current series of data, the associative table (FIG. 9) and the changeover candidate list (FIG. 11), and executes the paging-through process (S5), the pinning process (S9), the pinning releasing process (S11), the fiducial mode start process (S13) and the fiducial mode process (S14). Note that the pages displayed in the plurality of windows may not necessarily be the consecutive pages.

FIG. 13 is a flowchart illustrating the paging-through process by the paging-through processing unit 10C. In the paging-through process, the paging-through processing unit 10C acquires, at first, a paging-through count (S41). The event processing unit 10B sets the paging-through count in processes of S3-S7 in FIG. 12. Note that the paging-through count is set to “+1” or set to “−1” in the processes of FIG. 12. The event processing unit 10B may, however, set the paging-through count to a larger value than “+1” and to a smaller value than “−1”. For example, the user repeats the flick operation on a touch pad and other equivalent devices a plural number of times, in which case the event processing unit 10B may multiply the paging-through count by this flick operation count.

The paging-through processing unit 10C executes the following processes per window (S42). The paging-through processing unit 10C checks whether the clip flag is true (T) or false (F) (S43). When the clip flag is false (F; “No”), the paging-through processing unit 10C sets a value obtained by adding the paging-through count to the page number as a new page number in the associative table (FIG. 9) (S44). Whereas when the clip flag is true (T), the paging-through processing unit 10C sets the page number intact as the new page number in the associative table (FIG. 9) (S45).

The paging-through processing unit 10C further determines whether the new page number is within a page range defined by a minimum value and a maximum value of the page number in the series of data (S46). When the new page number is not within the page range defined by the minimum value and the maximum value of the page number in the series of data, the paging-through processing unit 10C finishes processing. To be specific, when determined to be “false” (No) even once in S46 in the window-by-window process, the paging-through processing unit 10C finishes the paging-through process. In the Example 1, the paging-through processing unit 10C terminates the paging-through process when even one new page number not existing within the page range is detected in the determination of S46 because of being disabled from paging through beyond the last page. Note that when the new page number is not within the page range, the paging-through processing unit 10C may return some sort of feedback to the user. The feedback is exemplified by displaying an indication, an alarm message and other equivalent notices, which give a visual effect of reaching the last page.

After carrying out the processes in S42-S46 with respect to the windows with the window count being designated in S42 (S47), the paging-through processing unit 10C replaces the page number in the associative table with the new page number (S48). Finally, the paging-through processing unit 10C extract the data specified by the series ID of the current series of data and by each page number from the document page data storage unit 10E, and stores the extracted data in the data retaining areas, associated with the respective windows, of the display data storage unit 10D (S49). Note that the display data storage unit 10D is set in the main storage device 12 or a memory of an unillustrated graphic board.

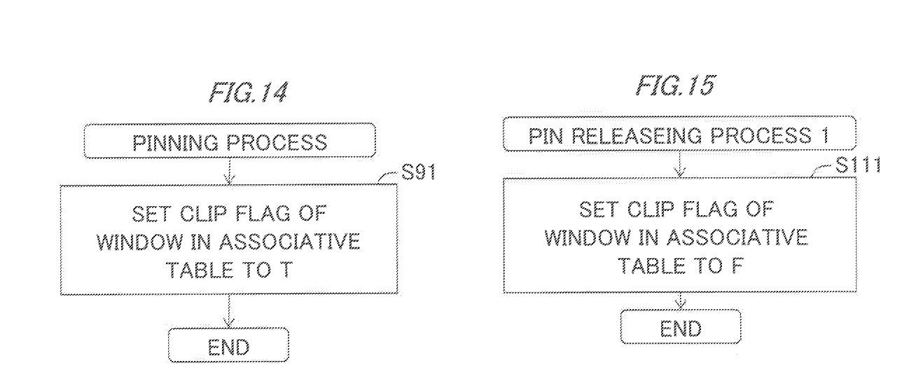

FIG. 14 illustrates the pinning process of the paging-through processing unit 10C. In the pinning process, the paging-through processing unit 10C sets “true” (T) the clip flag of the relevant window in the associative table in response to the event based on the user's operation (S91).

FIG. 15 illustrates the pinning releasing process of the paging-through processing unit 10C. In the pinning releasing process, the paging-through processing unit 10C sets “false” (F) the clip flag of the relevant window in the associative table in response to the event based on the user's operation (S111).

FIG. 16 illustrates the fiducial mode start process of the paging-through processing unit 10C. In the fiducial mode start process, the paging-through processing unit 10C saves the window number of the window with the occurrence of the event as a fiducial window number in the main storage device 12 (S131). The paging-through processing unit 10C refers to the page attribution table (FIG. 10), and thus extracts an aggregation of plural series of data containing the page displayed currently in the fiducial window. The paging-through processing unit 10C generates the changeover candidate list organized to have records of data, i.e., the series ID, the page number of the relevant page in each series, and the sequence number, and saves the generated list in the main storage device 12 (S132). The sequence numbers are integer values that are consecutive when the series of data displayed in the current window is set to 0 in the changeover candidates. For example, it is assumed that the series of data are sorted based on the series IDs when extracting the aggregation of plural series of data, and four series of data having line IDs=3, 4, 6 and 7 are extracted. When current series has the series ID=6, a sequence number of the series of data specified by the series ID=6 is “0”, a sequence number of the series of data specified by the series ID=4 is “−1”, a sequence number of the series of data specified by the series ID=3 is “−2”, and a sequence number of the series of data specified by the series ID=7 is “1”.

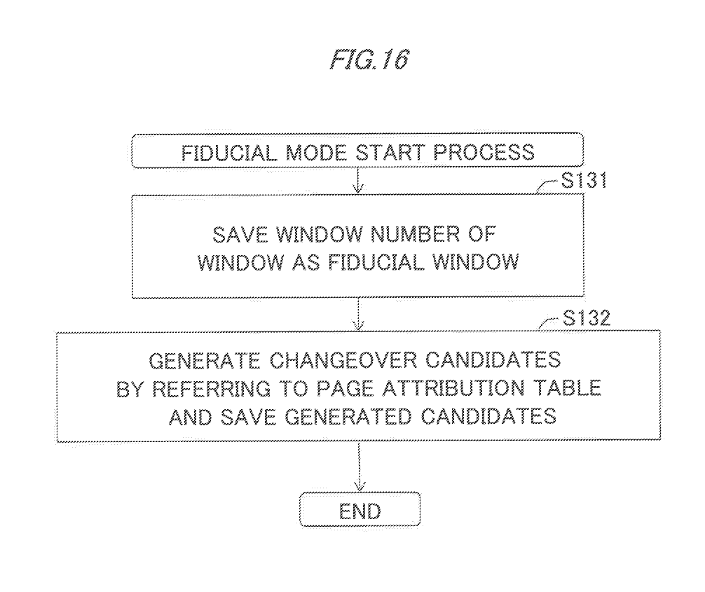

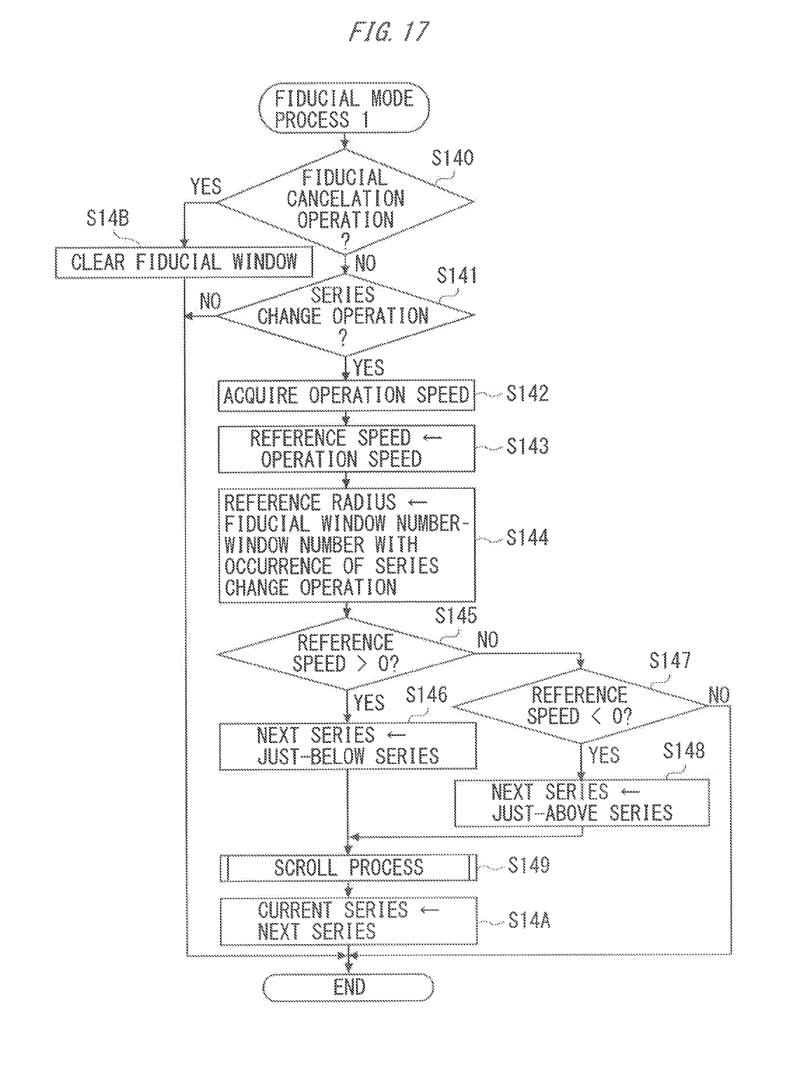

FIG. 17 is a flowchart illustrating the fiducial mode process by the paging-through processing unit 10C in the Example 1. In the fiducial mode process, the paging-through processing unit 10C determines a type of event, and executes a process corresponding to the type of event. Note that the fiducial mode process in the Example 1 is called a fiducial mode process 1.

When the event is a fiducial cancelation operation (“Yes” in S140), the paging-through processing unit 10C clears the fiducial window (S14B), and finishes the fiducial mode process. When the event is a series change operation (“Yes” in S141), the paging-through processing unit 10C acquires, at first, an operation speed of the user (S142). The paging-through processing unit 10C, to begin with, executes a process in S141 by way of one example of detecting a series change operation.

Herein, the operation speed is obtained by dividing, e.g., a shift pixel count of a shift in a predetermined direction of the pointing device instanced by the touch panel and other equivalent devices by a period of time expended for this shift. Herein, the predetermined direction is exemplified by a direction, orthogonal to the respective pieces of data, of the series of data currently displayed when, e.g., one series of data is displayed in the plurality of windows. For example, when one series of data is displayed in three windows disposed crosswise in the side-by-side relation, it may be sufficient that the paging-through processing unit 10C set an up-and-down direction of the window, which is orthogonal to the crosswise direction, as the predetermined direction. The paging-through processing unit 10C may also, however, simply detect the paging-through operation in the predetermined direction on the window other than the fiducial window irrespective of a mutual positional relation between the plural windows. The operation speed is to have a positive value when an action of the operation is directed upward with respect to the window and a negative value when directed downward.

Next, the paging-through processing unit 10C saves the operation speed of the user as a reference speed in the main storage device 12 (S143). The paging-through processing unit 10C saves a difference between the window number of the fiducial window and the window number of the window with the series change operation being detected as a reference radius in the main storage device 12 (S144).

Next, the paging-through processing unit 10C determines whether the reference speed takes a positive or negative value (S145, S147). When the reference speed takes the positive value, the paging-through processing unit 10C selects the just-below series as a next series (S146). While on the other hand, when the reference speed takes the negative value, the paging-through processing unit 10C selects the just-above series as the next series (S148). Then, the paging-through processing unit 10C executes a scroll process (S149). The paging-through processing unit 10C replaces a current series with the selected next series, and saves the replaced series in the main storage device 12 (S14A). Note that when the reference speed is “0”, the paging-through processing unit 10C finishes the fiducial mode process. The paging-through processing unit 10C executes the processes in S142-S14A by way of one example of a series change unit.

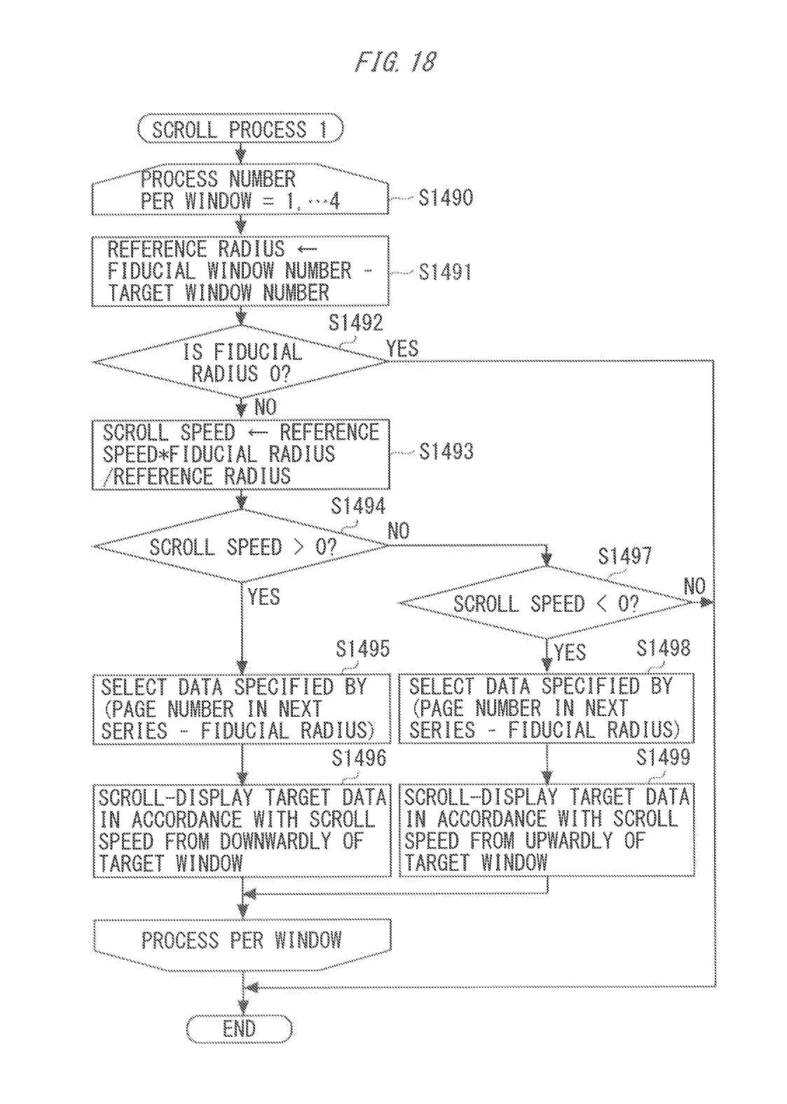

FIG. 18 is a flowchart illustrating details of the scroll process (S149 in FIG. 17) performed in the fiducial mode process 1. The scroll process performed in the fiducial mode process 1 is called a scroll process 1. The scroll process 1 is a process of changing the data of the current series displayed in another window other than the fiducial window to data having predetermined page numbers of another series while fixing the display of the fiducial window. The predetermined page numbers of another series of data connote page numbers sequenced based on the page number of the data currently displayed in the fiducial window.

For example, the fiducial window has the window number=2, and the page number of the data of the fiducial window is “10” in the series of data after the changeover of the series of data, in which case the data having the page number=9 is displayed in the window specified by the window number=1 after the scroll process. Further, the data having the page number=11 is displayed in the window specified by the window number=3 after the scroll process. The scroll process 1 will hereinafter be described based on FIG. 18.

In processes of FIG. 18, the paging-through processing unit 10C executes the following processes with respect to the windows specified by, e.g., the window numbers 1 through 4 (S1490). The paging-through processing unit 10C calculates a difference between a fiducial window number and a processing target window number, and sets the calculated difference as a fiducial radius (S1491). The processing target connotes any one of the windows having the window numbers 1 through 4 with the current data display process being executed.

The paging-through processing unit 10C determines whether the fiducial radius is “0” (S1492). The paging-through processing unit 10C does nothing about the window having “0” as the fiducial radius. The window having “0” as the fiducial radius is the fiducial window.

In the case of the window having the fiducial radius of not “0” but a different value, the paging-through processing unit 10C, at first, calculates a formula (Reference Speed*Fiducial Radius/Reference Radius) to obtain a scroll speed (S1493). The scroll speed is one example of a display change speed. The reference radius is one example of first relative information. The fiducial radius is one example of second relative information. By the process in S1493, the processing target window has the scroll speed that is set slower as being closer to the fiducial window but faster as being farther from the fiducial window. The paging-through processing unit 10C executes the process in S1493 by way of one example of calculating a display change speed.

The paging-through processing unit 10C executes, though different in terms of details of the process depending on whether “positive” or “negative” the value of fiducial radius is, the following processes for the next series set by the fiducial mode process 1. To be specific, when the scroll speed takes the positive value, the paging-through processing unit 10C searches the page attribution table for the data specified by a calculation of (page number−fiducial radius) on the basis of the page number in the next series of the data of the fiducial window, thus selecting the specified data (S1495). The data having the page number shifted by the fiducial radius from the page number of the fiducial window is allocated as the data of each window through the calculation (page number−fiducial radius). The fiducial radius is a differential value, which is calculated by the process in S1491, between the window number of the processing target window and the window number of the fiducial window. It therefore follows that the data having the page number shifted by the window number from the fiducial window is selected by the process in S1495. The paging-through processing unit 10C scroll-displays the data determined in S1495 in accordance with the scroll speed from downwardly of the window (S1496).

Similarly, when the scroll speed takes the negative value, the paging-through processing unit 10C searches the page attribution table for the data specified by the calculation of (page number−fiducial radius) on the basis of the page number in the next series of the data in the fiducial window, thus selecting the specified data (S1498). The paging-through processing unit 10C scroll-displays the data determined in S1498 in accordance with the scroll speed from upwardly of the window (S1499). The paging-through processing unit 10C executes the processes in S1494 through S1499 by way of one example of displaying the series of data by a changeover from a first series of data to a second series of data in each of the plurality of windows, based on the calculated display change speed. In other words, the scroll direction of the paging-through processing unit 10C is reversed corresponding to “positive” or “negative” of the scroll speed.

Note that the paging-through processing unit 10C can use a variety of techniques for scroll-displaying the data. For example, the paging-through processing unit 10C may decelerate the scroll speed at a fixed ratio, then set the scroll speed at “0” as at the display target data being completely displayed, and thus finish the scroll display. Alternatively, the paging-through processing unit 10C, when the data to be displayed at a fixed scroll speed without performing the deceleration thereof occupy the display area at a fixed ratio or larger, e.g., occupy a 90% display area or larger, may stop scrolling by setting the scroll speed at “0”, and display the data in the whole display area.

### Operational Example

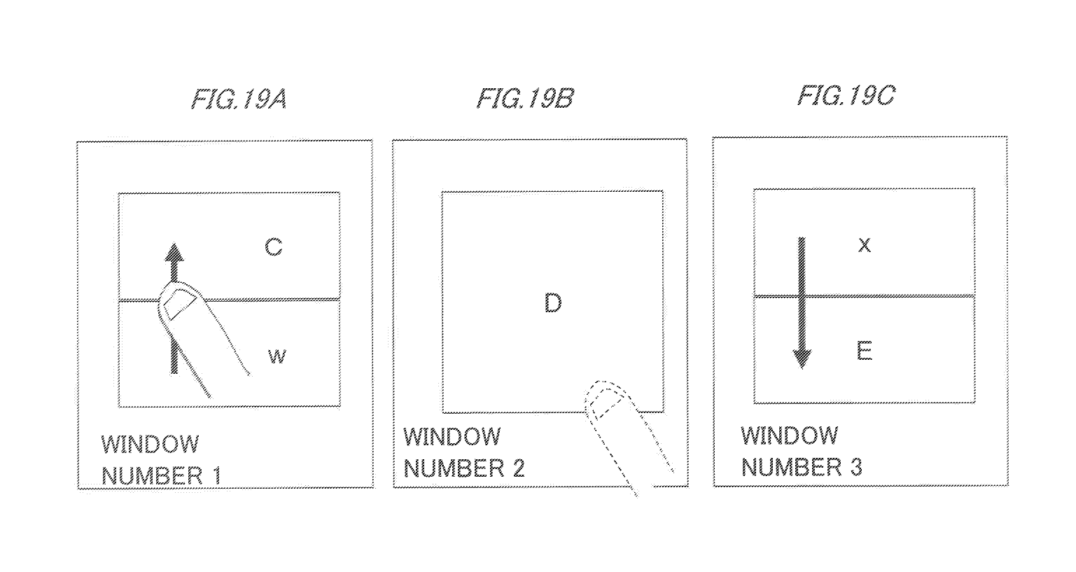

FIGS. 19A-21C are views depicting operations on the screens by taking the windows 1-3 of the Example 1 for instance. As stated above, the fiducial mode instruction operation is attained by, e.g., keeping the touch panel pressed against the window. The fiducial cancelation operation is attained by, e.g., releasing a pressing finger from the touch panel. The series change operation is attained by flicking in an upward or downward direction on the touch panel in the widow other than the fiducial window in the fiducial mode.

In the examples of FIGS. 19A, 19B and 19C, for instance, the user keeps pressing against the window having the window number 2, whereby the event processing unit 10B receives a press event in continuation from the OS and the paging-through processing unit 10C executes the fiducial mode start process. Then, the paging-through processing unit 10C sets the window having the window number 2 as the fiducial window. Subsequently, the paging-through processing unit 10C generates the changeover candidate list about the data in the window having the window number 2. Herein, an assumption is that the current series is a series of data containing a string of data such as “ . . . C, D, E . . . ”, and the just-below series is a series of data containing a string of data such as “ . . . w, D, x . . . ”.

Next, the user flicks in the upward direction in the window having the window number 1, whereby the event processing unit 10B receives an upward flick event from the OS and the paging-through processing unit 10C executes a process of the series change operation. To be specific, the paging-through processing unit 10C obtains a positive reference speed and a reference radius given by “fiducial window number−window number”, i.e., “2−1=1”. The paging-through processing unit 10C scroll-displays, in the upward direction from downward, the data w with an index existing one before the data D in the just-below series at the scroll speed equal to the reference speed in the window having the window number 1 (FIG. 19A). In parallel with the process in FIG. 19A, the paging-through processing unit 10C scroll-displays, in the downward direction from upward, the data x with an index existing one after the data D in the just-below series at a scroll speed given by (Reference Speed*(−1)/1) in the window having the window number 3.

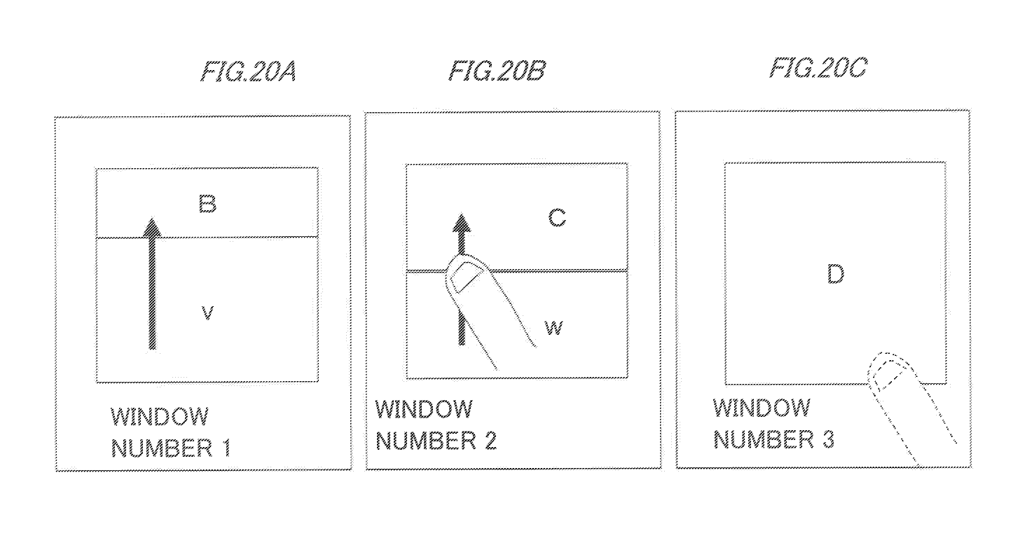

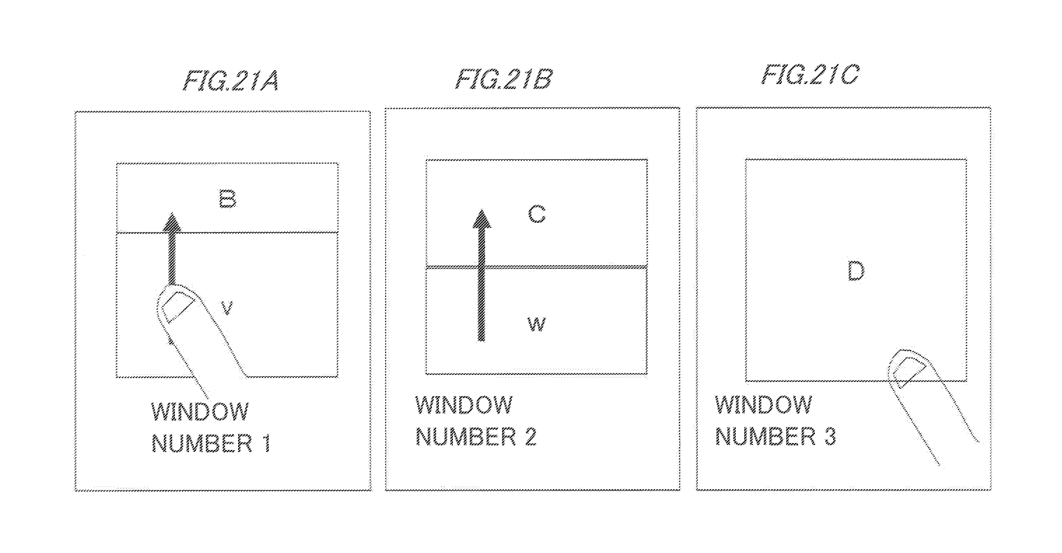

In the examples of FIGS. 20A, 20B and 20C, for instance, the user keeps pressing against the window having the window number 3, whereby the event processing unit 10B receives the press event in continuation from the OS and the paging-through processing unit 10C executes the fiducial mode start process. Then, the paging-through processing unit 10C sets the window 3 as the fiducial window. The paging-through processing unit 10C generates the changeover candidate list about the data in the window 3. Herein, it is assumed that the current series is a series of data containing a string of data such as “ . . . B, C, D . . . ”, and the just-below series is a series of data containing a string of data such as “ . . . v, w, D . . . ”.

Next, the user flicks in the upward direction in the window having the window number 2, whereby the event processing unit 10B receives the upward flick event from the OS and the paging-through processing unit 10C executes the process of the series change operation. To be specific, the paging-through processing unit 10C obtains the positive reference speed and the reference radius given by “fiducial window number−window number”, i.e., “3−2=1”. The paging-through processing unit 10C scroll-displays the data v with an index existing two before the data D in the just-below line at the scroll speed given by (Reference Speed*2/1) in the window having the window number 1. The paging-through processing unit 10C further scroll-displays the data w with an index existing one before the data D in the just-below line at the scroll speed given by (Reference Speed*1/1) in the window having the window number 2.

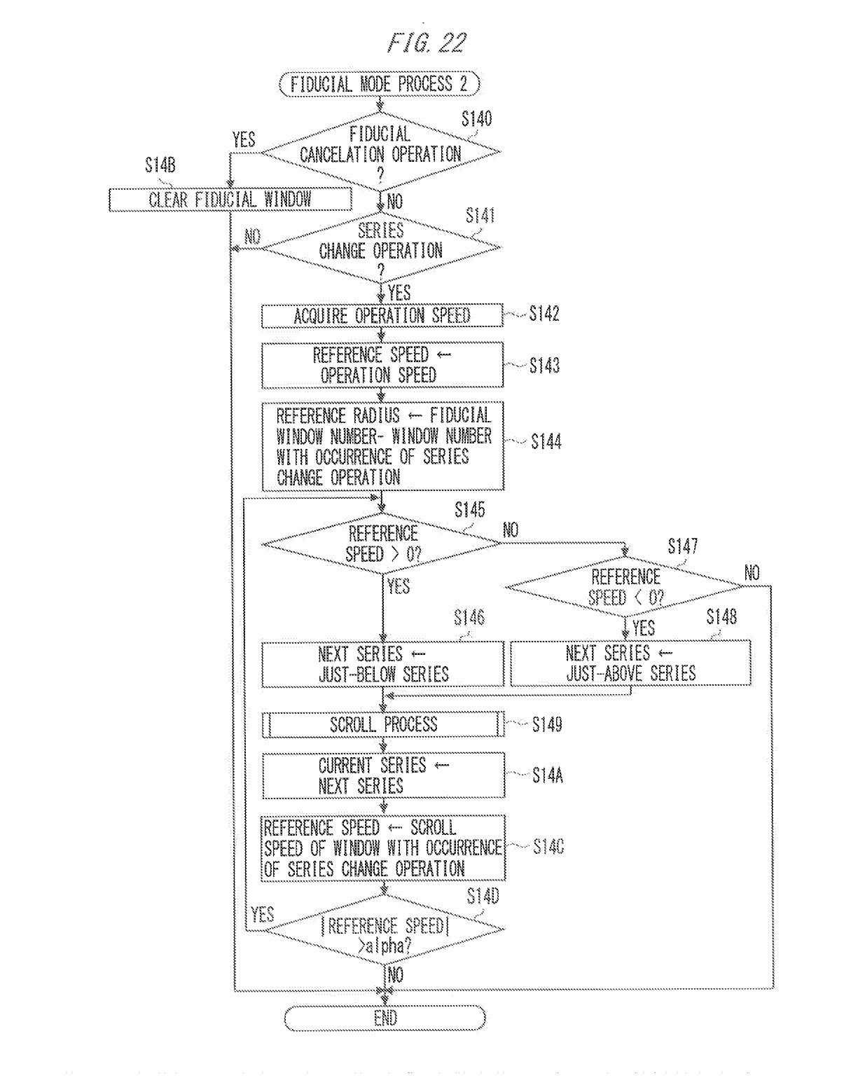

In the examples of FIGS. 21 through 21C, for instance, the user keeps pressing against the window having the window number 3, whereby the event processing unit 10B receives the press event in continuation from the OS and the paging-through processing unit 10C executes the fiducial mode start process. Then, the paging-through processing unit 10C sets the window 3 as the fiducial window. The paging-through processing unit 10C generates the changeover candidate list about the data in the window 3. In FIGS. 21 through 21C also, it is assumed that the current series is the series of data containing the string of data such as “ . . . B, C, D . . . ”, and the just-below series is the series of data containing the string of data such as “ . . . v, w, D . . . ”.

Next, the user flicks in the upward direction in the window having the window number 1, whereby the event processing unit 10B receives the upward flick event from the OS and the paging-through processing unit 10C executes the process of the series change operation. Specifically, the paging-through processing unit 10C obtains the positive reference speed and the reference radius given by “fiducial window number−window number”, i.e., “3−1=2”. The paging-through processing unit 10C scroll-displays the data v with the index existing two before the data D in the just-below series at the scroll speed given by (Reference Speed*2/2) in the window having the window number 1. The paging-through processing unit 10C further scroll-displays the data w with the index existing one before the data D in the just-below series at the scroll speed given by (Reference Speed*1/2) in the window having the window number 2.

As described above, the paging-through processing unit 10C of the information processing apparatus 10 changes the series of data displayed in the plurality of windows in the following manner. Specifically, in the status of any one of the plurality of windows being designated as the fiducial window, when the predetermined event such as the flick operation is detected in the window other than the fiducial window, the paging-through processing unit 10C determines changeover destination series of data, based on the detected event. The paging-through processing unit 10C determines, based on the page number with the fiducial window being used a benchmark, the data to be displayed in the respective windows, and displays the determined data of the series in the respective windows. Therefore, according to the information processing apparatus 10, the display of the fiducial window is kept, and the data to be displayed in the window other than the fiducial window is changed corresponding to the operation on the window other than the fiducial window. Hence, the information processing apparatus 10 enables the user to change the series of data displayed in the plurality of windows by the operation that is intuitively understandable to the user.

The change of the series of data involves acquiring, as the reference radius, the window number based distance between the fiducial window and the window with the event being detected. The operation speed on the window with the event is detected as the reference speed. The change of the series of data further involves determining the scroll speed of each window from the reference speed, based on the ratio of the fiducial radius between each window and the fiducial window to the reference radius. As a result, the paging-through operation concordant between the windows is attained to perform the change of the series of data.

### Example 2

A second example (Example 2) will exemplify a process for modifying the scroll display in the Example 1. To be specific, in the Example 2, the paging-through processing unit 10C of the information processing apparatus 10 performs the scroll display by decelerating the scroll speed with an elapse of time at the fixed ratio. Just when the data of the post-changing series of data are displayed in the respective windows, the paging-through processing unit 10C determines whether the scroll speed is equal to or larger than a fixed threshold. When the scroll speed is equal to or larger than the fixed threshold as at completing the display change to a new series of data, the paging-through processing unit 10C further changes the series of data displayed to a next series of data, and causes the scroll display to be done. Processes in the Example 2 other than the processes described above are the same as those in the Example 1. The configuration of the information processing apparatus 10 in the Example 2 is the same as the configuration in the Example 1. Accordingly, the information processing apparatus 10 is to have, e.g., the processing blocks in FIG. 7 and the hardware configuration in FIG. 8.

FIG. 22 is a flowchart illustrating a fiducial mode process (which is called a fiducial mode process 2) in the Example 2. As described above, the paging-through processing unit 10C in the Example 2 performs the scroll display by decelerating the scroll speed with the elapse of time at the fixed ratio when changing the series of data. A scroll process in the Example 2 is called a scroll process 2.

In FIG. 22, the processes other than S149A, S14A, S14C and S14D are the same as the processes of the scroll process 1 in the Example 1. Such being the case, in FIG. 22, the same processes as the processes of the scroll process 1 in the Example 1 are marked with the same numerals and symbols as those of the scroll process 1 in the Example 1, and their explanations are omitted.

As stated above, the paging-through processing unit 10C executes the scroll process 2 (S149A). Similarly to Example 1, the paging-through processing unit 10C replaces the current series of data with the next series of data selected in S145-S148, and stores the replaced series of data in the main storage device 12 (S14A).

Next, the paging-through processing unit 10C sets a current scroll speed in the window with the occurrence of the series of data change operation to a new reference speed (S14C). The paging-through processing unit 10C determines whether an absolute value of the new reference speed is larger than a predefined minimum speed alpha (S14D). The paging-through processing unit 10C, when the absolute value of the new reference speed is larger than the predefined minimum speed alpha, shifts the processing to S145. Thus, the paging-through processing unit 10C executes the scroll process by changing the series of data to a further next just-below series or just-above lineseries. The paging-through processing unit 10C executes the process in S14D by way of one example of determining whether a display change speed is within a predetermined range.

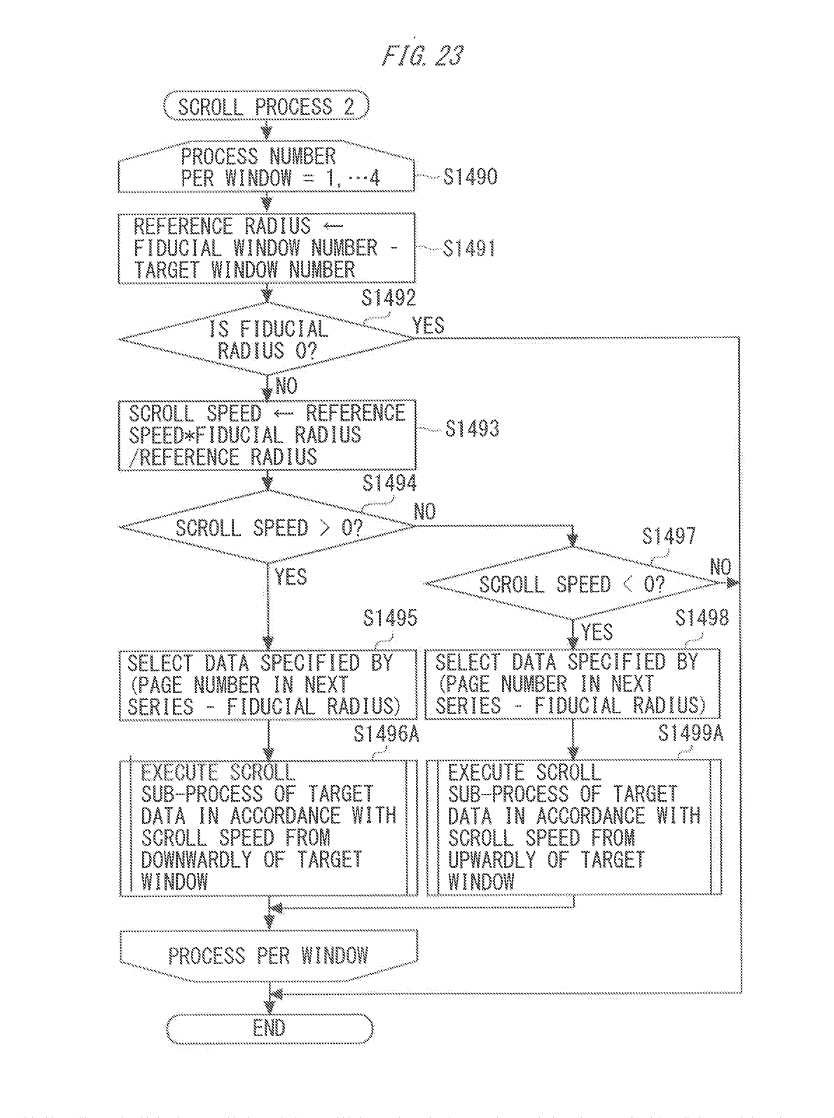

FIG. 23 is a flowchart illustrating the scroll process 2. In the scroll process 2, the processes other than processes in S1496A and 1499A are the same as those of the scroll process 1 in the Example 1. Such being the case, in the scroll process 2, the same processes as the processes of the scroll process 1 in the Example 1 are marked with the same numerals and symbols as those of the scroll process 1 in the Example 1, and their explanations are omitted.

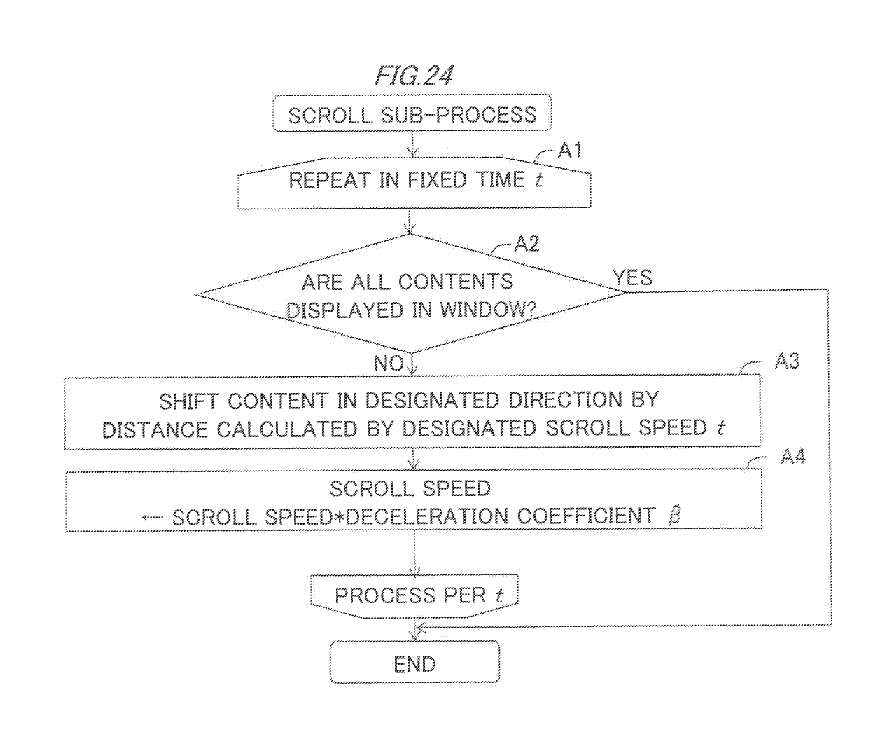

For example, when the scroll speed takes a positive value, the paging-through processing unit 10C selects, from the page attribution table, the data of an index specified by (Next Series Page Number−Fiducial Radius) (S1495). The paging-through processing unit 10C executes a scroll sub-process of scrolling the relevant data from downwardly of the window at the scroll speed set as an initial speed (51496A). An in-depth description of the scroll sub-process will be made later in FIG. 24.

Whereas when the scroll speed takes a negative value, the paging-through processing unit 10C selects, from the page attribution table, the data of an index specified by (Next Series Page Number−Fiducial Radius) (S1498). The paging-through processing unit 10C executes the scroll sub-process of scrolling the relevant data from upwardly of the window at the scroll speed set as the initial speed (S1499A).

FIG. 24 is a flowchart illustrating the scroll sub-process. The scroll sub-process is executed in parallel in the respective windows. The scroll sub-process entails executing a loop process at every preset minute time interval t, depending on a CPU throughput and an image display capability of the terminal (A1). In the scroll sub-process, the paging-through processing unit 10C finishes processing when the relevant data given by the scroll process is all displayed in the window (“Yes” in A2). Whereas when the relevant data is not all displayed (“No” in A2), the paging-through processing unit 10C shifts a content thereof at a distance calculated by (Designated Scroll Speed×t) in a designated direction (A3). Thereafter, the paging-through processing unit 10C calculates a new scroll speed by multiplying the current scroll speed by a previously given deceleration coefficient β smaller than “1” (A4). The paging-through processing unit 10C executes the process in A4 by way of one example of reducing a display change speed at a predetermined ratio.

Then, the paging-through processing unit 10C continues the loop process. In the Example 2, when the scroll sub-process is finished in all of the windows, the paging-through processing unit 10C shifts to an end process of the scroll process 2.

As discussed above, the information processing apparatus 10 in the Example 2, when changing over the series of data to be displayed in the window, gradually decelerates the scroll speed of the data displayed in each window, and further determines whether the display changeover to the next data line is conducted corresponding to the scroll speed just when completing the display changeover to the next series of data Specifically, when the scroll speed as at completing the display changeover to the next series of data is larger than the predefined threshold value alpha, the paging-through processing unit 10C further performs the display changeover to the next series of data. Accordingly, when the plurality of series of data exists and when the user changes over the series of data to be displayed in the window, the information processing apparatus 10 can provide the user with a sense of changeover operation by skipping one or more series of data corresponding to the operation speed of the user. It may be sufficient that the user performs, e.g., the flick operation at a fixed or higher speed than a speed of the flick operation when conducting the changeover to the just-above or just-below series neighboring to the currently displayed data line. The flick operation at the fixed or higher speed enables the user to execute the display changeover to the series of data farther distanced from the neighboring just-above or just-below series of data by skipping this neighboring series.

### Example 3

A third example exemplifies a plurality of terminals communicating with each other in place of the information processing apparatuses in the Example 1 and Example 2. A server in the Example 3 provides the plurality of terminals with document page data and the page attribution table. The plurality of terminals cooperating with each other is combined with the server to configure a system called an information system in the Example 3.

Note that the terminal is, e.g., a mobile terminal. In the information system of the Example 3, however, it does not mean that the terminal is limited to the mobile terminal. Each terminal has one or more windows. The plurality of terminals cooperates with each other to execute the same processes as by the information processing apparatus in the Example 1 or 2. For example, the single windows displayed on the display devices of the plurality of terminals are combined to display one series of data. The plurality of terminals cooperates with each other to change over and thus display the series of data in a group of combined windows. On the other hand, the server manages and provides the document page data and the page attribution table to the respective terminals. A hardware configuration of the terminal is the same as the configuration of the information processing apparatus 10 in the Example 1. However, when the terminal is the mobile terminal, the communication interface 14 is provided with a wireless communication unit. A hardware configuration of a server 9 is the same as the configuration of the information processing apparatus 10 in the Example 1.

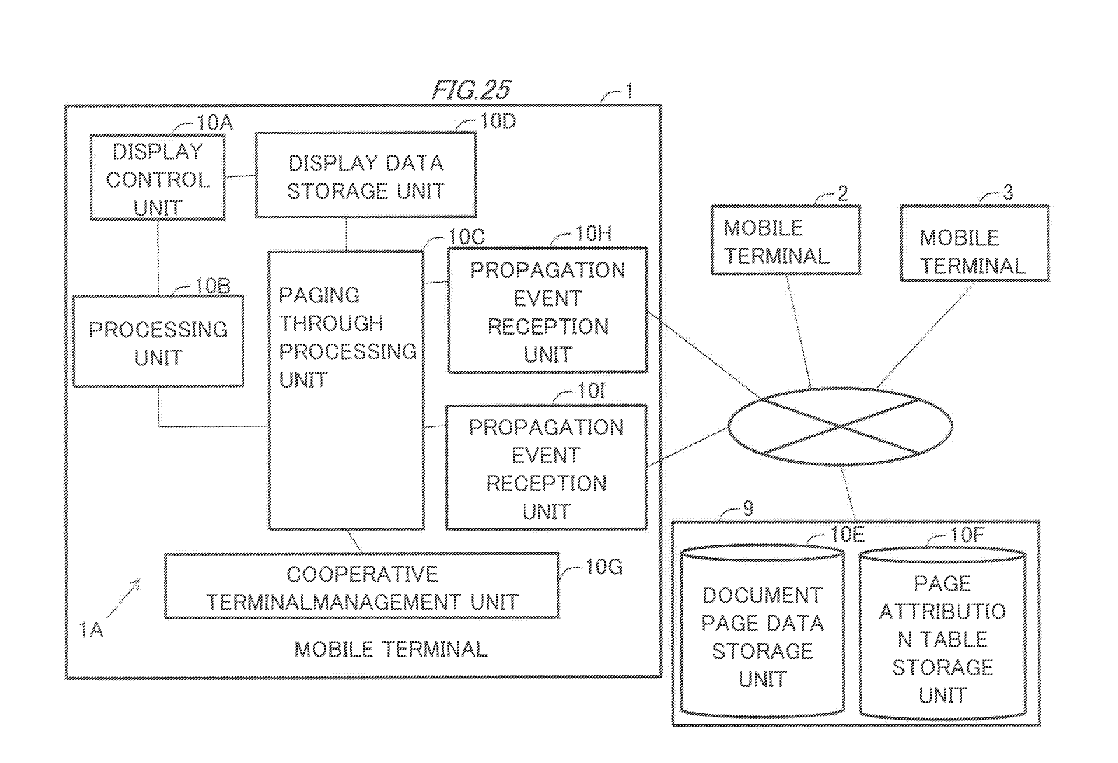

FIG. 25 is a diagram illustrating a configuration of function blocks of the information system in the Example 3. The server 9, a terminal 1, a terminal 2 and a terminal 3 are interconnected via a network. Note that the terminals 1-3 are, when generically termed, simply called the terminal(s). In the Example 3, it does not mean that the number of terminals is restricted to “3”. Each terminal is different from the information processing apparatuses 10 of the Examples 1 and 2 in terms of not having the document page data and the page attribution table. Each terminal is further different from the information processing apparatuses 10 of the Examples 1 and 2 in terms of including a cooperative terminal management unit 10G, a propagation event reception unit 10H and a propagation event transmission unit 10I. Similarly to the information processing apparatuses 10 of the Examples 1 and 2, however, each terminal includes the display control unit 10A, the event processing unit 10B, the paging-through processing unit 10C, and the display data storage unit 10D. Note that FIG. 25 illustrates the processing blocks of the terminal 1, and, however, the processing blocks of each of the terminals 2 and 3 are the same as those of the terminal 1.

On the other hand, the server 9 includes the document page data storage unit 10E and a page attribution table storage unit 10F. Each terminal accesses the server 9 via the network, and refers to the data of the document page data storage unit 10E and the data of the page attribution table storage unit 10F.

The cooperative terminal management unit 10G retains an associative relation between the window numbers and IP addresses of the terminals having the windows specified by the window numbers. The propagation event reception unit 10H receives the event transmitted from another terminal, and transfers the received event to the paging-through processing unit 10C. The process of propagation event reception unit 10H is one example of receiving, from a third computer, an instruction of changeover a series of data to be displayed in at least one of the plurality of windows of the a computer from the first series of data to a second series of data.

Herein, the event transmitted from another terminal is called a propagation event. By the way, a propagation event process executed by the propagation event reception unit 10H is to process the event occurring on another terminal, and, however, the event processing unit 10B executes the process of the event occurring on the window of the self terminal according to the event process (FIG. 12) similarly to the Example 1. For instance, the event processing unit 10B, similarly to the Example 1, executes the process in S13 of FIG. 12 as a unit to set the self window displayed by the paging-through processing unit 10C on the display device 16 as the fiducial window according to the operation on the input device 17.

The propagation event transmission unit 10I transfers, to another terminal, the event occurring on the terminal 1 and processed by the paging-through processing unit 10C. The process of propagation event transmission unit 10I is one example of transmitting as a first computer, to a second computer, an instruction of changeover a series of data to be displayed in one or more windows of the second computer from the first series of data to a second series of data.

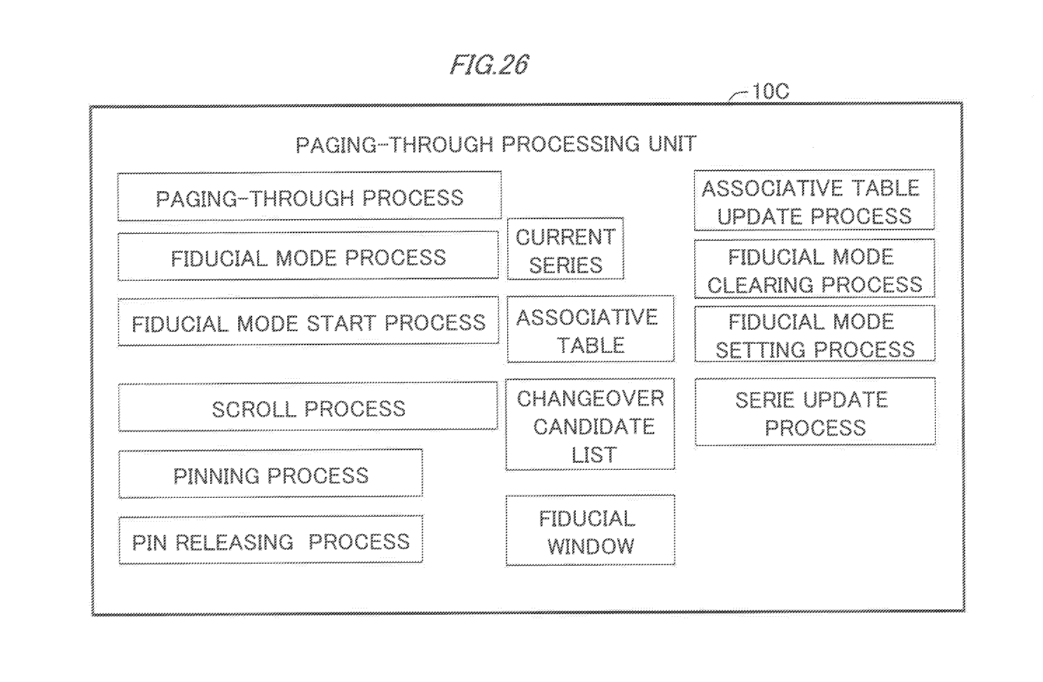

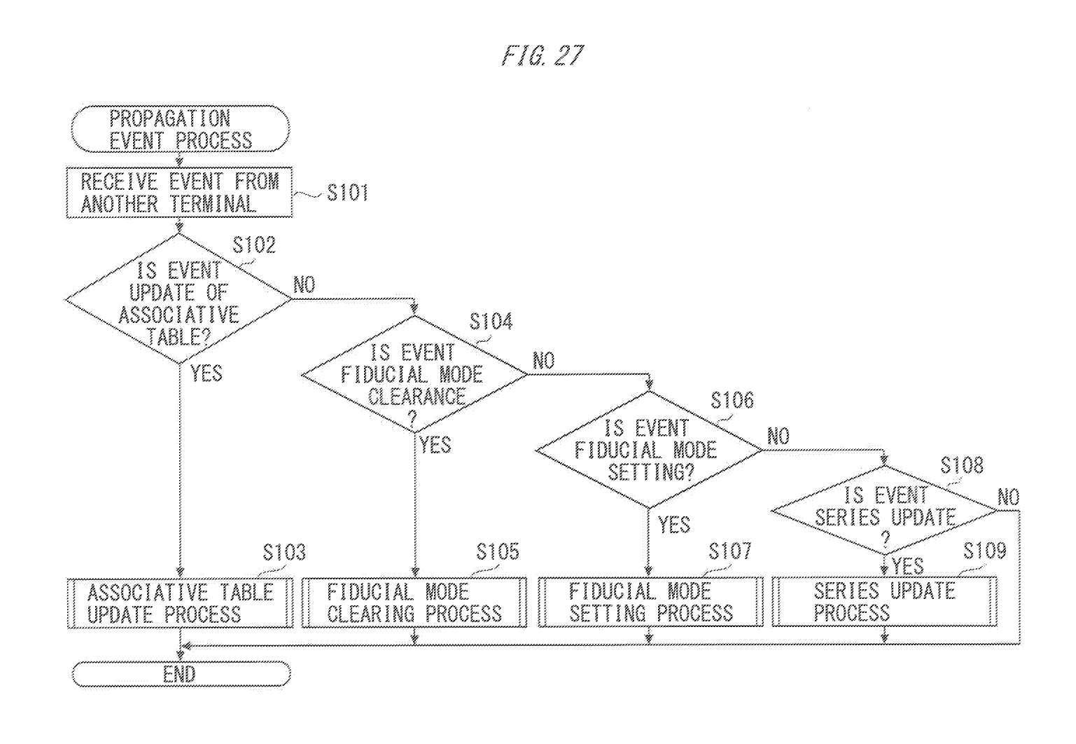

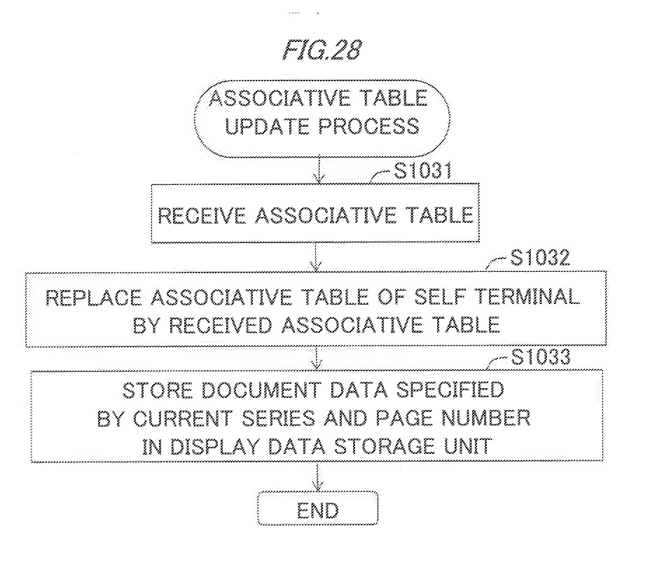

FIG. 26 illustrates function blocks of the paging-through processing unit 10C in the Example 3. The paging-through processing unit 10C in the Example 3 executes processes, i.e., an associative table update process, a fiducial mode clearing process, a fiducial mode setting process, a series update process, a paging-through process, a fiducial mode process, a pinning process and a pinning releasing process. Note that in the paging-through process, the scroll process, the pinning process, the pinning releasing process, the fiducial mode start process and the fiducial mode process in the Example 3, each terminal, unlike the information processing apparatuses 10 of the Examples 1 and 2, executes a process of performing communications with other terminals. Details of the respective processes will be described later in accordance with flowcharts in FIGS. 27 through 37. Note that the paging-through processing unit 10C stores the current series, the associative table, the changeover candidate list and the window number of the fiducial window in the main storage device 12.

FIG. 27 is a flowchart illustrating the propagation event process of the propagation event reception unit 10H. When the terminal receives the event from another terminal (S101), the propagation event reception unit 10H executes processes from S101 onward in FIG. 27.

When the received event is an associative table update event (“Yes” in S102), the propagation event reception unit 10H executes an associative table update process (S103). When the received event is a fiducial mode clearing event (“Yes” in S104), the propagation event reception unit 10H executes the fiducial mode clearing process (S105). When the received event is a fiducial mode setting event (“Yes” in S106), the propagation event reception unit 10H executes the fiducial mode setting process by the paging-through processing unit 10C (S107). The propagation event reception unit 10H executes the processes in S101 and S106 by way of one example receiving, from a third computer, information for identifying a fiducial window set in the third computer.

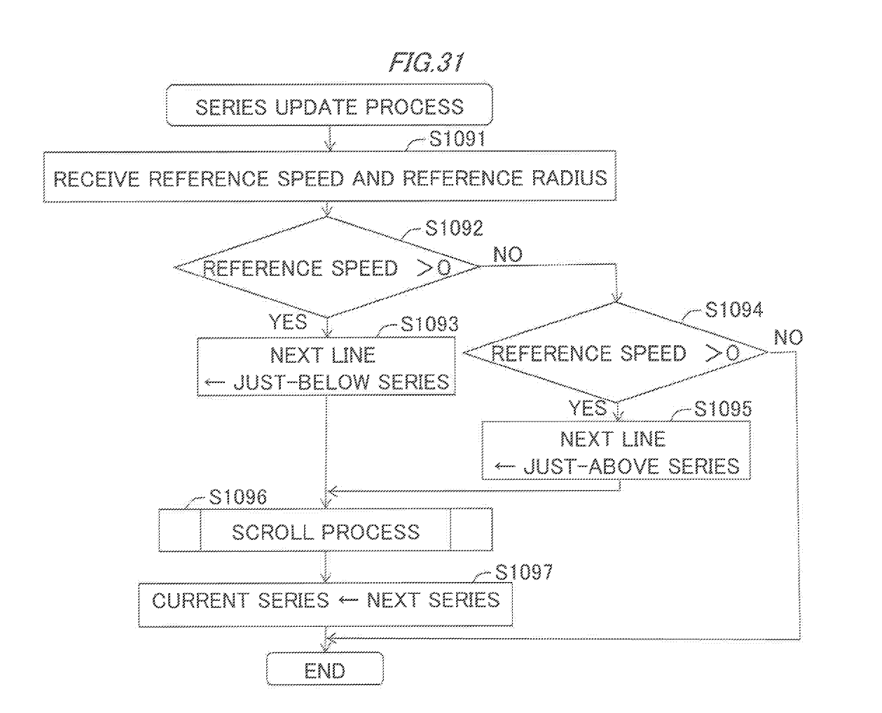

When the received event is a series update event (“Yes” in S108), the propagation event reception unit 10H executes the series update process by the paging-through processing unit 10C (S109). The propagation event reception unit 10H executes the processes in S101 and S108 by way of one example of receiving an instruction of changing over a series of data to be displayed in the one or more windows of a first computer from the first series of data to the second series of data. FIG. 28 is a flowchart illustrating the associative table update process. The process in FIG. 28 is a process in which each terminal updates the associative table containing the page numbers, the clip flags and the new page numbers, which are displayed in the window of the self terminal and the windows of other terminals. A structure of the associative table is the same as in FIG. 9 according to the example 1. Note that each terminal stores, in the main storage device 12, the window number of the window displayed on the self terminal and the series ID of the series of data (current series of data) displayed in the window of each of the terminals of the information system. The series ID of the current series of data is updated in a series update process (see FIG. 31).

In the process of FIG. 28, the paging-through processing unit 10C receives the associative table via the propagation event reception unit 10H (S1031), and replaces, e.g., the current associative table retained in the main storage device 12 by the received associative table (S1032). The paging-through processing unit 10C searches the associative table on the basis of the window number of the window currently displayed on the self terminal, thereby acquiring the page number of the page to be displayed in the window of the self terminal. The paging-through processing unit 10C stores the series ID of the current series and document data specified by the page number in the display data storage unit 10D (S1033). Through the process in S1033, the paging-through processing unit 10C displays the data specified by the page number in the associative table in the window of the self terminal.

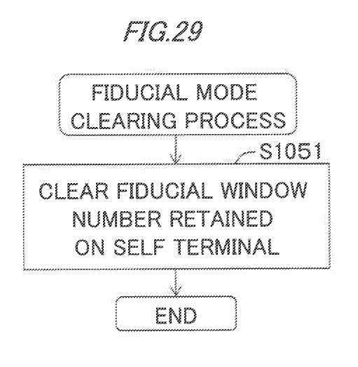

FIG. 29 is a flowchart illustrating the fiducial mode clearing process with respect to the fiducial mode clearing event. The paging-through processing unit 10C clears the fiducial window number retained on the self terminal (S1051).

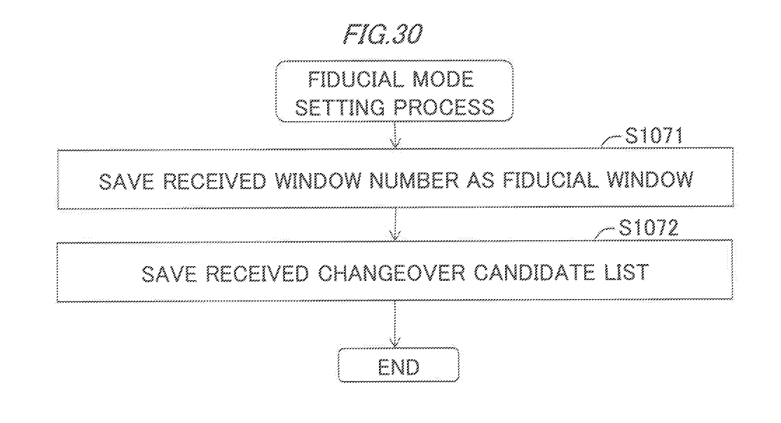

FIG. 30 is a flowchart illustrating an operation of the fiducial mode setting process with respect to the fiducial mode setting event. Note that each terminal receives, as will be described later in FIG. 35, the window number of the fiducial window and the changeover candidate list along with receiving the fiducial mode setting event. The paging-through processing unit 10C saves the window number received via the propagation event reception unit 10H as the fiducial window (S1071). The paging-through processing unit 10C replaces the current changeover candidate list retained on the main storage device 12 of the self terminal by the received changeover candidate list. A structure of the changeover candidate list is the same as in FIG. 11 of the Example 1.

FIG. 31 is a flowchart illustrating an operation of the series update process. In the series update process, the paging-through processing unit 10C receives, at first, the reference speed and the reference radius via the propagation event reception unit 10H (S1091). When the reference speed takes a positive value (“Yes” in S1092), the paging-through processing unit 10C sets the line ID of the just-below series as the series ID of the next series (S1093). When the reference speed takes a negative value (“Yes” in S1094), the paging-through processing unit 10C sets the series ID of the just-above series as the series ID of the next series (S1095). Next, the paging-through processing unit 10C executes the scroll process (S1096) and, after finishing the scroll process, replaces the series ID of the current series by the series ID of the next series (S1097).

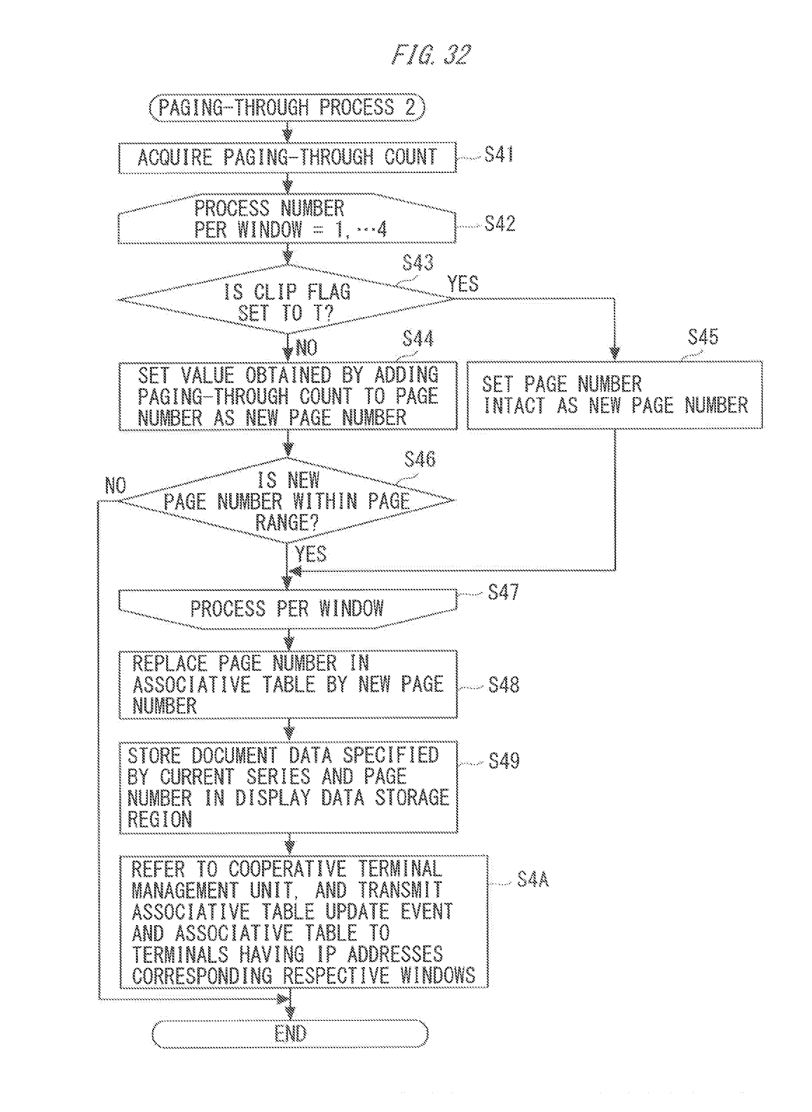

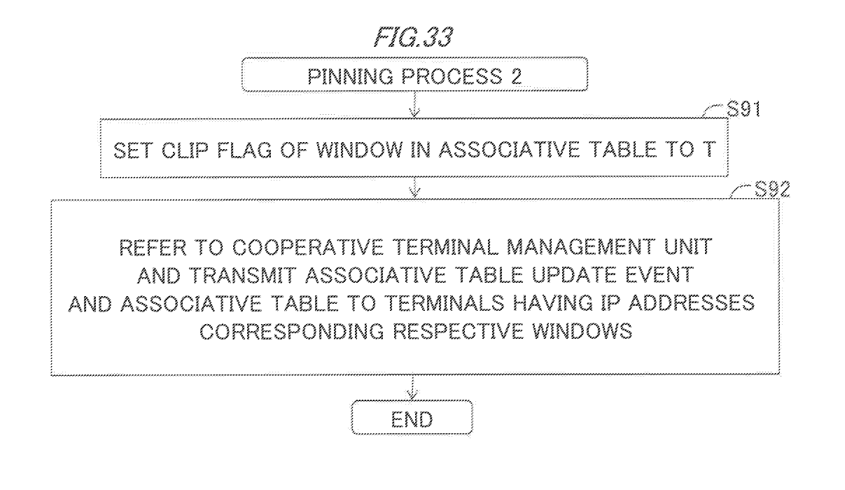

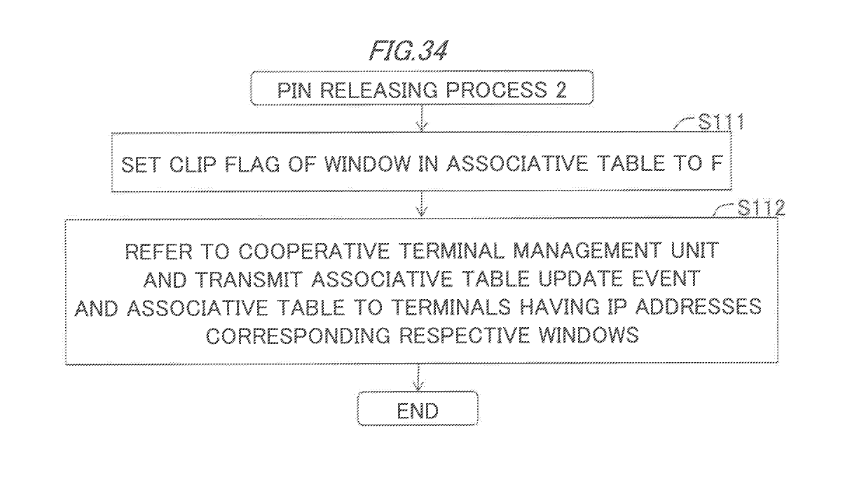

FIG. 32 is a flowchart illustrating the paging-through process in the example 3. The paging-through processing unit 10C, after executing the same paging-through process as in the Example 1, executes a cooperative process with other terminals. In FIG. 33, the same processes as those in the Example 1 are marked with the same numerals and symbols. Processes in S41 through S49 are the same as those in the Example 1, and hence their explanations are omitted. After the process in S49, the paging-through processing unit 10C transmits the associative table update event and the associative table to other terminals via the propagation event transmission unit 10I. For example, the propagation event transmission unit 10I refers to the cooperative terminal management unit 10G to acquire the IP address of the terminal that displays each window. The propagation event transmission unit 10I transmits the associative table update event and the associative table to the terminals having the IP addresses corresponding the respective windows (S4A).

FIG. 33 is a flowchart illustrating the pinning process in the Example 3. To begin with, the paging-through processing unit 10C performs the same operation as in the Example 1 (S91). Next, the paging-through processing unit 10C transmits the associative table update event and the associative table to other terminals via the propagation event transmission unit 10I. For instance, the propagation event transmission unit 10I refers to the cooperative terminal management unit 10G, and transmits the associative table update event and the associative table to the terminals having the IP addresses corresponding the respective windows (S92).

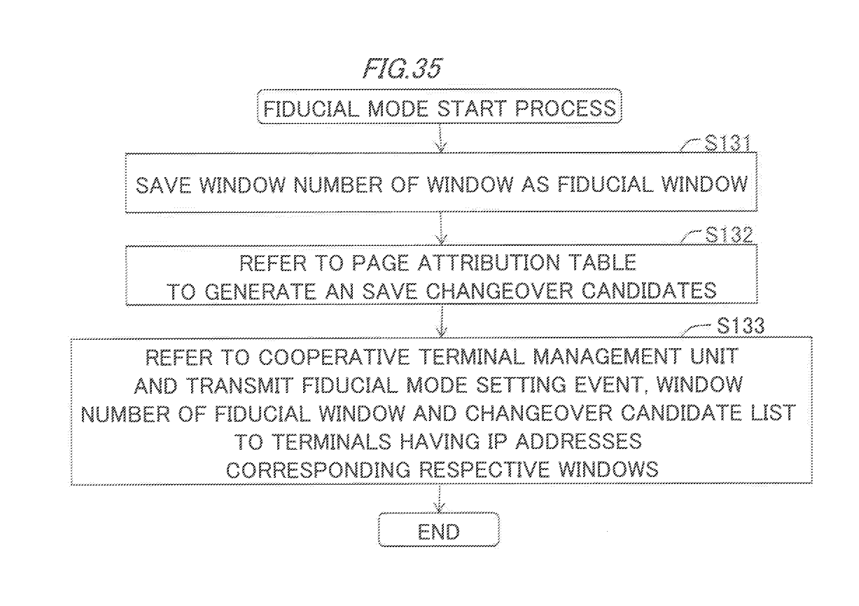

FIG. 34 is a flowchart illustrating the pinning cancelation process in the Example 3. At first, the paging-through processing unit 10C performs the same operation as in the Example 1 (S111). The paging-through processing unit 10C transmits the associative table update event and the associative table to other terminals via the propagation event transmission unit 10I. The propagation event transmission unit 10I refers to, e.g., the cooperative terminal management unit 10G, and transmits the associative table update event and the associative table to the terminals having the IP addresses corresponding the respective windows (S112).

FIG. 35 is a flowchart illustrating the fiducial mode start process in the Example 3. At first, the paging-through processing unit 10C conducts the same operation as in the Example 1 (S131, S132). Next, the paging-through processing unit 10C transmits the fiducial mode setting event, the window number of the fiducial window and the changeover candidate list via the propagation event transmission unit 10I to other terminals. The propagation event transmission unit 10I refers to, e.g., the cooperative terminal management unit 10G, and transmits the fiducial mode setting event, the window number of the fiducial window and the changeover candidate list to the terminals having the IP addresses corresponding the respective windows (S133). The paging-through processing unit 10C executes the process in S133 by way of one example of transmitting information for identifying the fiducial window to a second computer of the plurality of computers.

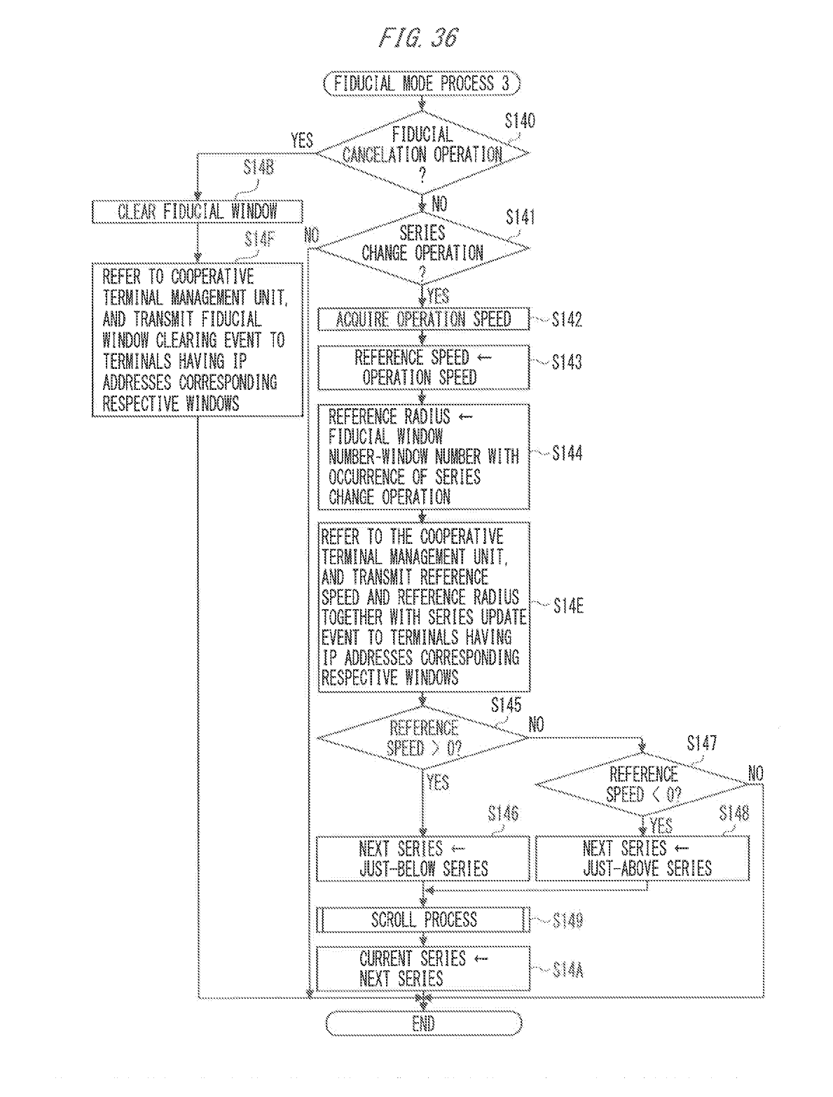

FIG. 36 is a flowchart illustrating the fiducial mode process in the Example 3. The fiducial mode process in the Example 3 is called a fiducial mode process 3. The same processes in the fiducial mode process 3 as those in the fiducial mode process 1 (FIG. 17) in the Example 1 are marked with the same numerals and symbols, and their explanations are simplified.

In other words, different processes in the fiducial mode process 3 of FIG. 36 from those in the fiducial mode process 1 are S14F and S14E. To be specific, when the event is a fiducial cancelation operation (“Yes” in S140) the paging-through processing unit 10C executes a cooperative process with other terminals after clearing the fiducial window (S14B). For example, the paging-through processing unit 10C transmits the fiducial window clearing event to other terminals via the propagation event transmission unit 10I. The propagation event transmission unit 10I refers to the cooperative terminal management unit 10G, then transmits the fiducial window clearing event to the terminals having the IP addresses corresponding respective windows, and finishes the fiducial mode process (S14F).

Similarly to the Example 1, a determination in S141 involves determining whether the event is the line change operation. When the event is the line change operation (“Yes” in S141), the paging-through processing unit 10C acquires an operation speed of the user (S142). The operation speed is obtained by, e.g., dividing a Y-directional shift pixel count of the pointing device by a period of time expended for a shift. The operation speed is to have a positive value when the operation shift is directed upwardly of the window but a negative value when directed downwardly of the window. The paging-through processing unit 10C sets the operation speed of the user as the reference speed (S143). The paging-through processing unit 10C sets, as the reference radius, a difference between the window number of the fiducial window and the window number of the window with the occurrence of the series change operation (S144). The paging-through processing unit 10C transmits the reference speed and the reference radius together with the series update event to other terminals via the propagation event transmission unit 10I. For instance, the propagation event transmission unit 10I refers to the cooperative terminal management unit 10G, and transmits the reference speed and the reference radius together with the series update event to the terminals having the IP addresses corresponding respective windows (S14E). The paging-through processing unit 10C executes the process in S14E by way of one example of transmitting an instruction of changing over a series of data to be displayed in the one or more window of the second computer from the first series of data to the second series of data.

The paging-through processing unit 10C further selects the just-below series as the next series when the reference speed takes the positive value (“Yes” in S145) (S146), and selects the just-above series as the next series when the reference speed takes the negative value (“Yes” in S147) (S148). When the reference speed is “0”, the paging-through processing unit 10C finishes the fiducial mode process. The paging-through processing unit 10C, after executing the same scroll process as in the Examples 1 and 2, replaces the current line with the selected next series (S14A).

The operations described above enable the plurality of terminals on the network to perform the same operations as those in the Example 1. As discussed above, according to the Example 3, even when the windows exist in distribution over the plurality of terminals, each terminal can set the fiducial window by detecting the user's operation in the same way as in the Examples 1 and 2. Each terminal can also change the series of data currently displayed in the plurality of windows to another series of data by detecting the user's operation on any one of the windows. Each terminal further can carry out the same scroll display as in the Examples 1 and 2 on the occasion of changing the data line to be displayed. Accordingly, each terminal can perform scrolling and can shift to the series of data in accordance with the window number based distance from the fiducial window or the speed of the flick operation on the window, and other equivalent data.

<Computer-Readable Non-Transitory Recording Medium>

A program for making a computer, other machines and devices (which will hereinafter be referred to as the computer etc) realize any one of the functions can be recorded on a non-transitory recording medium readable by the computer etc. Then, the computer etc is made to read and execute the program on this recording medium, whereby the function thereof can be provided.

Herein, the recording medium readable by the computer etc connotes a recording medium capable of accumulating information such as data and programs electrically, magnetically, optically, mechanically or by chemical action, which can be read by the computer etc. Among these recording mediums, for example, a flexible disc, a magneto-optic disc, a CD-ROM, a CD-R/W, a DVD, a Blu-ray disc, a DAT, an 8 mm tape, a memory card such as a flash memory, etc are given as those removable from the computer. Further, a hard disc, a ROM (Read-Only Memory), etc are given as the recording mediums fixed within the computer etc.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control device being connectable to a display device to display a plurality of windows and to an input device to detect operations on the plurality of windows, the control device comprising one or more processors and a storage device storing instructions, the instructions causing the one or more processors to execute a process comprising:
setting one of the plurality of windows as a fiducial window, based on an operation on the input device;
detecting a series change operation of changing over a series of data to be displayed in the plurality of windows from within a plurality of series of data containing data under display in the fiducial window, the detecting being done in any of the plurality of windows other than the fiducial window, based on an operation on the input device; and
changing over the series of data to be displayed in the plurality of windows from a first series of data to a second series of data in a status of fixing the data being displayed in the fiducial window, based on the series change operation.

2. The control device according to claim 1, the process further comprising:
calculating a display change speed in each of the plurality of windows in accordance with an operation speed based on the series change operation on a change operation window with the series change operation being detected, first relative information based on identifying information of the fiducial window and identifying information of the change operation window, and second relative information of the respective windows other than the change operation window, based on the identifying information of the fiducial window and the identifying information of the respective windows other than the change operation window; and
displaying the series of data by the changeover from the first series of data to the second series of data in each of the plurality of windows, based on the calculated display change speed.

3. The control device according to claim 1, the process further comprising:
reducing the display change speed at a predetermined ratio when displaying the series of data by the changeover from the first series of data to the second series of data;
determining whether the display change speed is within a predetermined range when completing the display changeover from the first series of data to the second series of data; and
repeating the change of the series of data to be displayed in the plurality of windows till the display change speed falls within the predetermined range by changing over the series of data to be displayed in the plurality of windows further from the second series of data to a third series of data when the display change speed is not within the predetermined range as at completing the changeover.

4. The control device according to claim 1, the control device being mounted on one computer, the process further comprising:
transmitting as a first computer, to a second computer, an instruction of changing over a series of data to be displayed in one or more windows of the second computer from the first series of data to the second series of data; and
receiving, from a third computer, an instruction of changing over a series of data to be displayed in at least one of the plurality of windows of the first computer from the first series of data to the second series of data.

5. An information system including a plurality of computers, each comprising:
a display device to display one or more windows;
an input device to detect an operation on any one of the one or more windows;
a control device to control the display device and the input device; and
a communication device to communicate with another information processing apparatus,
the control device comprising one or more processors and a storage device storing instructions causing the one or more processors to execute a process comprising:
setting, by a first computer of the plurality of computers, a first window displayed on the display device of the first computer as a fiducial window, based on an operation on the input device;
transmitting information for identifying the fiducial window to a second computer of the plurality of computers when the first window is set as the fiducial window;
receiving, from a third computer, information for identifying a fiducial window set in the third computer when a third window of the third computer is set as the fiducial window;
detecting a series change operation of changing a first series of data under display in one or more windows of the first computer and one or more windows of the second computer to a second series of data, the detecting being done in any of the one or more windows of the first computer other than the fiducial window, based on the operation on the input device;
transmitting an instruction of changing over a series of data to be displayed in the one or more window of the second computer from the first series of data to the second series of data in a status of fixing data being displayed in the fiducial window, based on the series change operation; and
receiving the instruction of changing over a series of data to be displayed in the one or more windows of the first computer from the first series of data to the second series of data, based on the series change operation on the third computer.

6. A display control method, comprising:
setting one of a plurality of windows as a fiducial window, based on an operation on an input device;
detecting a series change operation of changing over a series of data to be displayed in a plurality of windows from within a plurality of series of data containing data under display in the fiducial window, the detecting being done in any of the plurality of windows other than the fiducial window, based on an operation on the input device; and
changing over the series of data to be displayed in the plurality of windows from a first series of data to a second series of data in a status of fixing the data being displayed in the fiducial window, based on the series change operation.

7. The display control method according to claim 6, further comprising:
calculating a display change speed in each of the plurality of windows in accordance with an operation speed based on the series change operation on a change operation window with the series change operation being detected, first relative information based on identifying information of the fiducial window and identifying information of the change operation window, and second relative information of the respective windows other than the change operation window, based on the identifying information of the fiducial window and the identifying information of the respective windows other than the change operation window; and
displaying the series of data by the changeover from the first series of data to the second series of data in each of the plurality of windows, based on the calculated display change speed.

8. The display control method according to claim 6, further comprising:
reducing the display change speed at a predetermined ratio when displaying the series of data by the changeover from the first series of data to the second series of data;
determining whether the display change speed is within a predetermined range when completing the display changeover from the first series of data to the second series of data; and
repeating the change of the series of data to be displayed in the plurality of windows till the display change speed falls within the predetermined range by changing over the series of data to be displayed in the plurality of windows further from the second series of data to a third series of data when the display change speed is not within the predetermined range as at completing the changeover.

9. The display control method according to claim 6, further comprising:
transmitting as a first computer, to a second computer, an instruction of changing over a series of data to be displayed in one or more windows of the second computer from the first series of data to the second series of data; and
receiving, from a third computer, an instruction of changing over a series of data to be displayed in at least one of the plurality of windows of the first computer from the first series of data to the second series of data.

10. An information processing method of an information system including a plurality of computers each configured to display respective one or more windows, the method comprising:
setting, by a first computer of the plurality of computers, a first window of the first computer as a fiducial window, based on an operation on an input device;
transmitting information for identifying the fiducial window to a second computer of the plurality of computers when the first window is set as the fiducial window;
receiving, from a third computer, information for identifying a fiducial window set in the third computer when a third window of the third computer is set as the fiducial window;
detecting a series change operation of changing a first series of data under display in one or more windows of the first computer and one or more windows of the second computer to a second series of data, the detecting being done in any of the one or more windows of the first computer other than the fiducial window, based on the operation on the input device;
transmitting an instruction of changing over a series of data to be displayed in the one or more windows of the second computer from the first series of data to the second series of data in a status of fixing data being displayed in the fiducial window, based on the series change operation on the first computer; and
receiving the instruction of changing over a series of data to be displayed in the one or more windows of the first computer from the first series of data to the second series of data, based on the series change operation on the third computer.

11. A computer-readable non-transitory recording medium having stored therein a program for causing a computer to execute a process comprising:
setting one of a plurality of windows as a fiducial window, based on an operation on an input device;
detecting a series change operation of changing over a series of data to be displayed in a plurality of windows from within a plurality of series of data containing data under display in the fiducial window, the detecting being done in any of the plurality of windows other than the fiducial window, based on an operation on the input device; and
changing over the series of data to be displayed in the plurality of windows from a first series of data to a second series of data in a status of fixing the data being displayed in the fiducial window, based on the series change operation.

12. The computer-readable non-transitory recording medium according to claim 11, the process further comprising:
calculating a display change speed in each of the plurality of windows in accordance with an operation speed based on the series change operation on a change operation window with the series change operation being detected, first relative information based on identifying information of the fiducial window and identifying information of the change operation window, and second relative information of the respective windows other than the change operation window, based on the identifying information of the fiducial window and the identifying information of the respective windows other than the change operation window; and
displaying the series of data by the changeover from the first series of data to the second series of data in each of the plurality of windows, based on the calculated display change speed.

13. The computer-readable non-transitory recording medium according to claim 11, the process further comprising:
reducing the display change speed at a predetermined ratio when displaying the series of data by the changeover from the first series of data to the second series of data;
determining whether the display change speed is within a predetermined range when completing the display changeover from the first series of data to the second series of data; and
repeating the change of the series of data to be displayed in the plurality of windows till the display change speed falls within the predetermined range by changing over the series of data to be displayed in the plurality of windows further from the second series of data to a third series of data when the display change speed is not within the predetermined range as at completing the changeover.

14. The computer-readable non-transitory recording medium according to claim 11, the process further comprising:
transmitting as a first computer, to a second computer, an instruction of changing over a series of data to be displayed in one or more windows of the second computer from the first series of data to the second series of data; and
receiving, from a third computer, an instruction of changing over a series of data to be displayed in at least one of the plurality of windows of the first computer from the first series of data to the second series of data.

15. A computer-readable non-transitory recording medium having stored therein a program for causing a computer of a plurality of computers to execute a process comprising:
setting, by a first computer of the plurality of computers, a first window of the first computer as a fiducial window, based on an operation on an input device;
transmitting information for identifying the fiducial window to a second computer of the plurality of computers when the first window is set as the fiducial window;
receiving, from a third computer, information for identifying a fiducial window set in the third computer when a third window of the third computer is set as the fiducial window;
detecting a series change operation of changing a first series of data under display in one or more windows of the first computer and one or more window of the second computer to a second series of data, the detecting being done in any of the one or more windows of the first computer other than the fiducial window, based on the operation on the input device;
transmitting an instruction of changing over a series of data to be displayed in the one or more windows of the second computer from the first series of data to the second series of data in a status of fixing data to be displayed in the fiducial window, based on the series change operation on the first computer; and
receiving the instruction of changing over a series of data to be displayed in the one or more windows of the first computer from the first series of data to the second series of data, based on the series change operation on the third computer.
